(19) United States
(12) Patent Application Publication
(10) Pub. No.: US 2023/0309502 A1
(43) Pub. Date: Oct. 5, 2023

(54) ANIMAL LITTER COMPOSITIONS AND METHOD OF AMMONIA ABATEMENT

(71) Applicant: Controlled Release Technologies, Inc., Shelby, NC (US)

(72) Inventor: Joseph M. Serpico, Shelby, NC (US)

(73) Assignee: Controlled Release Technologies, Inc., Shelby, NC (US)

(21) Appl. No.: 17/674,810

(22) Filed: Feb. 17, 2022

(51) Int. Cl. A01K 1/015; A01K 23/00

(52) U.S. Cl. CPC A01K 1/0155; A01K 23/005

(57) ABSTRACT

An animal litter treatment composition comprising: at least one sulfo-oxo compound defined by formula:

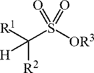

wherein R¹ and R² are independently hydrogen, a substituted or unsubstituted alkyl, a substituted or unsubstituted alkenyl, a substituted or unsubstituted aryl, amino, a substituted or unsubstituted alkylamino, halide, a substituted or unsubstituted haloalkyl, hydroxy, a substituted or unsubstituted hydroxyalkyl, or a substituted or unsubstituted alkoxyalkyl, optionally, R¹ and R² together with the carbon the are attached form a ring of 3-7 atoms, and R³ is hydrogen, (un)substituted alkyl, (un)substituted alkenyl, (un)substituted aryl, (un)substituted sulfonyl radical resulting in a (un)substituted sulfonic anhydride or (un)substituted carbonyl radical resulting in a symmetrical or asymmetrical sulfonic-carboxylic anhydride, optionally, R² and R³ together with sulfur, the carbon and the oxygen they are attached, form a ring of 5-7 atoms, is disclosed. A method of reducing ammonia level of an animal litter using the composition is also disclosed.

### TECHNICAL FIELD

This disclosure is directed to a composition and method of treating animal litter to reduce ammonia and conserve urea for fertilizer use.

### BACKGROUND

Animal litter treatments, more formally known as litter amendments, have been used in animal facilities for many years with varied results. The principal use of a litter amendment is to control ammonia levels in the air where the animals live and grow, the house. There are three major concerns in the food industry in no specific order: (1) productivity with efficiency, (2) health and safety, and (3) practical utility. In the broiler industry, for example, managing the environment of the poultry house to keep both the farmers and the chicks healthy is the core challenge. Ammonia levels must be kept under control. NIOSH set the permissible exposure limit of ammonia for humans at 25 ppm averaged over an eight-hour workday. USDA recommends a maximum level of ammonia in poultry houses to be 25 ppm for chickens to reach a healthy body weight. Ventilation is one way to reduce ammonia levels the reduction in moisture content of the litter reduces rate of the ammonia volatilization from litter due to decomposition of the excreta by bacteria. In addition, the exhaust of ammonia-laden air reduces ammonia levels in the broiler house but may be detrimental to air quality in the local environment around the houses. In addition, high ventilation rates in the poultry house become impractical especially in the winter where the house must be heated to keep the chickens comfortable and healthy. Acidifying litter amendments such as dry alum, i.e., aluminum sulfate, sodium bisulfate and ferric sulfate all provide adequate ammonia control by suppression of ammonia volatilization. Each of these amendments have their drawbacks, sodium bisulfate requires heat for a minimum of 2 days for activation, and aluminum, and ferrous sulfates require moisture activation for a minimum 3 to 5 days before chicks can be placed. In addition, only acidified alum, ca. aluminum sulfate combined with sulfuric acid keeps ammonia levels down below the threshold value, i.e., 25 ppm for 7 days after the chick placement and only when and if, farmers up the ventilation rate.

However, the practical nature of the problem faced by animal feeding operations is the excreta that is generated during the grow-out, e.g., by the broiler chicks as they mature, bacteria in the upper layers of litter decompose the urate salts, urea and other organic matter volatilizing ammonia that kills productivity on the farm. Therefore, what is needed is an animal litter treatment that controls ammonia at the source, in the litter, during grow-out and does so for an extended (release) period so chicks can thrive and reach a healthy body weight. Enhanced productivity and greater efficiency can be achieved with a shortened activation period for the litter amendment without heat, added moisture, over-ventilation, or multiple application rates.

At the end of the growing season, animal litter houses, and particularly poultry broiler houses, are typically cleaned out and filled with fresh litter. A more popular practice, known as “windrowing”, is a process whereby built-up litter that has been used for several flocks’ generations and is saturated with excreta, is regenerated by adjusting the moisture content and piling the litter up in rows. When a temperature of greater than 55° C. is reached within the core of the litter row by action of bacteria, the population of non-thermophilic pathogens is reduced to safe levels. However, windrowing even with in-house sprinkler systems is not known to or effective in reducing ammonia volatilization of the used litter completely nor does the litter so treated provide for retention of organic nitrogen, such as urea, that otherwise would allow the windrowing litter to be used a fertilizer.

While it is known by those of ordinary skill that spreading a mineral acid or metal salt onto the litter reduces ammonia vapor levels in an animal house for about 2 to 5 days, this time frame is insufficient for ammonium abatement during a growth period of most animals, in particular, poultry.

### SUMMARY

In a first example, an animal litter treatment composition is provided, the composition comprising: at least one sulfo-oxo compound defined by formula:

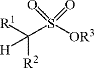

wherein R¹ and R² are independently hydrogen, a substituted or unsubstituted alkyl, a substituted or unsubstituted alkenyl, a substituted or unsubstituted aryl, amino, a substituted or unsubstituted alkylamino, halide, a substituted or unsubstituted haloalkyl, hydroxy, a substituted or unsubstituted hydroxyalkyl, or a substituted or unsubstituted alkoxyalkyl,
wherein, optionally, R¹ and R² together with the carbon the are attached form a substituted or unsubstituted cycloalkyl ring or a substituted or unsubstituted aryl ring, or a substituted or unsubstituted heteroaryl ring of 3-7 atoms,
R³ is hydrogen, a substituted or unsubstituted alkyl, a substituted or unsubstituted alkenyl, a substituted or unsubstituted aryl, a substituted or unsubstituted sulfonyl radical resulting in a symmetrical or asymmetrical sulfonic anhydride, or a substituted or unsubstituted carbonyl radical resulting in a symmetrical or asymmetrical sulfonic-carboxylic anhydride, or wherein, optionally, R² and R³ together with sulfur, the carbon and the oxygen they are attached, form a substituted or unsubstituted heteroalkyl or heteroalkenyl ring of 5-7 atoms; and
one or more carboxylic acids defined by formula:

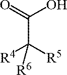

where R⁴, R⁵ and R⁶ are independently hydrogen, substituted or unsubstituted alkyl, substituted or unsubstituted alkenyl, substituted or unsubstituted aryl, substituted or unsubstituted cycloalkyl, vinyl, vinylalkyl, vinylaryl, halide, substituted or unsubstituted haloalkyl, hydroxy, substituted or unsubstituted hydroxyalkyl, substituted or unsubstituted alkoxyalkyl, carboxyl, alkylene carboxylate, vinyl carboxylate, allyl, allyl carboxylate, substituted or unsubstituted imino, phosphonobutyl, or pyruvyl, and wherein any two of R⁴, R⁵, and R⁶ can optionally be joined together with the carbon they are attached to form a substituted or unsubstituted cycloalkyl ring or a substituted or unsubstituted aryl ring, or a substituted or unsubstituted heteroaryl ring of 3-7 atoms.

In a one aspect, the sulfo-oxo compound is at least one of methanesulfonic acid, ethanesulfonic acid, 1-propanesulfonic acid, 2-propanesulfonic acid, 2-butanesulfonic acid, 3-butanesulfonic acid, and 4-butanesulfonic acid.

In another aspect, alone or in combination with any one of the previous aspects, the sulfo-oxo compound is at least one of hydroxymethanesulfonic acid, methoxy-methanesulfonic acid, aminomethansulfonic acid, difluoromethanesulfonic acid, dichloro-methanesulfonic acid, methanesulfonic anhydride, phenyl methanesulfonic acid, 2,6-dimethylphenyl methanesulfonic acid, 2-methoxyphenyl methanesulfonic acid, 2-phenyl-1-ethanesulfonic acid, 3-hydroxy-2-phenyl-1-ethane sulfonic acid, 2-(p-sulfophenyl-1-ethanesulfonic acid, 2-(2,4-disulfophenyl)-1-ethanesulfonic acid, phenyl methanesulfonate, methylphenyl methanesulfonate, p-(methylamino) phenyl methanesulfonate, 2-hydroxyethanesulfonic acid (isenthionic acid), 2-aminoethane-1-sulfonic acid (taurine), N-methyltaurine, N, N-dimethyltaurine, 1,3-propanesultone, 3-hydroxypropanesulfonic acid, 3-aminopropane-1-sulfonic acid (homotaurine), (R)-2-amino-3-sulfopropanoic acid (cysteate), 4-hydroxy-1-butanesulfonic acid, ethanesulfonic anhydride, 1-propanesulfonic anhydride, 2-propanesulfonic anhydride, 2-butanesulfonic anhydride, 3-butanesulfonic anhydride, 4-butanesulfonic anhydride, and difluoromethanesulfonic anhydride.

In another aspect, alone or in combination with any one of the previous aspects, the at least one carboxylic acid is an alpha-hydroxy acid.

In another aspect, alone or in combination with any one of the previous aspects, the at least one carboxylic acid is at least one of citric acid, isocitric acid, homocitric acid, prop-1-ene-1,2,3-tricarboxylic acid (aconitic acid), 2-phosphonobutane-1,2,4-tricarboxylic acid, malic acid, malonic acid, 2-hydroxy-2-phenylacetic acid (mandelic acid), tartaric acid, itaconic acid, oxaloacetic acid, adipic acid, glycolic acid, lactic acid, glutaric acid, 2-oxoglutaric acid, fumaric acid, succinic acid, gluconic acid, pyruvic acid, glyoxylic acid, salicylic acid, tropic acid, 3-hydroxy-3,7,11-trimethyldodecanoic acid (trethocanic acid), 2-hydroxybutanoic acid, 3-hydroxybutanoic acid, 4-hydroxybutanoic acid, and oxalic acid.

In another aspect, alone or in combination with any one of the previous aspects, the composition further comprises a urease inhibitor. In another aspect, alone or in combination with any one of the previous aspects, the urease inhibitor is at least one of N-(n-butyl)-thiophosphoric triamide, N-(n-butyl)-phosphoric triamide, N-(n-propyl)-thiophosphoric triamide, monoamidothiophosphoric acid, phenyl phosphorodiamidate, cyclohexylphosphoric triamide, N-(n-butyl)-N′-(methylolurea)-thiophosphoric triamide, N-(n-butyl)-N-(monomethylolurea)-thiophosphoric triamide, N-(n-butyl)-N′-(dimethylolurea)-thiophosphoric triamide, N-(n-butyl)-N′-poly(methylolurea)-thiophosphoric triamide, thiophos-phoryl triamide, phosphoryl triamide, dicyandiamide, 2-mercaptoethanol, cysteamine, boric acid, acetohydroxamic acid, humic acid, 1,4-benzoquinone, D-fructose, thiourea, dimethyl-thiourea, tetramethyl-thiourea, 2-{(E)-[(4-chlorophenyl)imino]-methyl}phenol copper(II), 2-{(E)-[(4-bromophenyl)-imino]methyl}phenol copper (II), [(Z)-2-methoxycarbonyl-3-(4-methylphenyl)prop-2-enyl]-phosphonic acid, 2-(N-3,4-dimethylpyrazole)succinic acid, and potassium dihydrogen phosphate.

In another aspect, alone or in combination with any one of the previous aspects, the composition further comprises one or more of a urea biosynthesis activator; a limiting substrate; an enzyme cofactor; a cofactor mediator; an antimicrobial agent; an amphiphilic phosphoric surfactant; and at least one of a terpene, a terpenoid, an odorant, a repellant, a nonionic hydrocarbon emulsifier, an antioxidant, a stabilizer, a polar dispersant, and an ionophoric electrolyte salt.

In another aspect, alone or in combination with any one of the previous aspects, the urea biosynthesis activator is at least one of N-acetyl-L-glutamate, N-acetyl-L-glutamic acid, N-acetyl-L-aspartate, N-acetyl-L-aspartic acid, N-acetyl-L-ornithine, N-acetyl-L-citrulline, N-acetyl-L-alanine, N-acetyl phosphate, N-carbamoyl-L-glutamate, N-carbamoyl-L-glutamic acid, N-carbamoyl-L-aspartate, N-carbamoyl-L-aspartic acid, N-carbamoyl phosphate, and (aminooxy) acetic acid.

In another aspect, alone or in combination with any one of the previous aspects, the limiting substrate is at least one of L-aspartic acid, L-ornithine-L-aspartate, L-citrulline-L-aspartate, L-arginine-L-aspartate, L-glutamic acid, and L-arginine-L-glutamate.

In another aspect, alone or in combination with any one of the previous aspects, the enzyme cofactor is at least one of magnesium acetate, magnesium aspartate, magnesium chloride, magnesium sulfate, magnesium carbonate, magnesium potassium orthophosphate, manganese acetate, manganese chloride, manganese chloride, manganese sulfate, manganese carbonate, and thiamine pyrophosphate.

In another aspect, alone or in combination with any one of the previous aspects, the cofactor mediator is at least one of zinc citrate, zinc gluconate, zinc lactate, zinc lactate citrate, zinc lactate malate, zinc acetate, zinc sulfate, zinc nitrate, zinc chloride, zinc phosphate, zinc carbonate, calcium carbonate, calcium acetate, calcium citrate, calcium gluconate, calcium lactate, calcium lactate citrate, calcium lactate malate, calcium sulfate, and calcium chloride.

In another aspect, alone or in combination with any one of the previous aspects, the antimicrobial agent is at least one of carvacrol, thymol, eugenol, o-eugenol, guaiacol, 2-allylcarvacrol, 4-allylcarvacrol, 4-allylthymol, quercetin, catechin, 3-acylcatechin, catechin gallate, epicatechin, 3-actyl epicatechin, epigallocatechin, epicatechin gallate, epigallocatechin gallate, catechol, carvone, pyrogallol, theaflavin, theaflavin-3-gallate, curcumin, procyanidin, resveratrol, pterostilbene, (E)-3-hydroxy-4′,5-dimethoxystilbene, δ-viniferin, 2,5-dihydroxybenzaldehyde, 2-hydroxy-4-methoxybenzaldehyde, 2-hydroxy-5-methoxybenzaldehyde, 2-hydroxycinnam-aldehyde, p-tert-amylphenol, and o-phenylphenol.

In another aspect, alone or in combination with any one of the previous aspects, the amphiphilic phosphoric surfactant is a phospholipid.

In another aspect, alone or in combination with any one of the previous aspects, the amphiphilic phosphoric surfactant is at least one of dioleoyl phosphatidylcholine, dilinoleoyl phosphatidylcholine, dioleoyl-linoleoyl phosphatidylcholine, linoleoyl-palmitoyl phosphatidylcholine, dimyristoyl phosphatidylcholine, dipalmitoyl phosphatidylethanolamine, 2-((2,3-bis(oleoyloxy)propyl) dimethylammonio) ethyl ethyl phosphate, 1-propanaminium, 3,3′,3″-[phosphinylidyne- tris(oxy)]-tris[N-(3-aminopropyl)-2-hydroxy-N,N-dimethyl-, N,N′,N″-tri-C6-C18 acyl trichloride, 1-propanaminium, 3,3′-[phosphinylidyne- bis(oxy)]-bis[N-(3-aminopropyl)-2-hydroxy-N,N-dimethyl-, N,N′-di-C6-18 acyl dichloride, 1-propanaminium, 3-[phosphinylidyne-(oxy)]-[N-(3-aminopropyl)-2-hydroxy-N,N-dimethyl-, N-C6-18 acyl monochloride, coco alkyl(2,3-dihydroxypropyl) dimethyl, 3-phosphate esters, chlorides, sodium salts, fructose-1,6-di-2-hydroxy-3-(N,N-dimethyl-N-(2-hydroxyethyl) ammoniopropyl-phosphate, and fructose-1,6-di-2-hydroxy-3-(N,N-dimethyl-N-pentylammonio) propyl phosphate.

In another aspect, alone or in combination with any one of the previous aspects, the terpene and/or terpenoid odorant and/or repellant is at least one of terpinene-4-ol, α-terpineol, α-terpinene, γ-terpinene, terpinolene, citral, citronellol, citronellal, citronellyl acetate, farnesol, furostanol, geraniol, geranyl acetate, geranyl alcohol, perillaldehyde, o-phthalaldehyde, pyrethrin, linalool, m-cymene, nerol, myrcene, thujone, verbenol, p-mentha-1,5-dien-8-ol, β-lonone, davanone, damascene, rhodinol, (+)-limonene, lupeol, betulin, betulinic acid, α-amyrin acetate, β-amyrin acetate, α-pinene, β-pinene, borneol, camphor, L-carveol, and L-carvone.

In another aspect, alone or in combination with any one of the previous aspects, the nonionic hydrocarbon emulsifier is at least one of poly(oxy-1,2-ethanediyl), α, a′, α″- 1,2,3-propanetriyl-tris (ω-hydroxy-, dodecanoate, poly(oxy-1,2-ethanediyl), α, α′, α″- 1,2,3-propanetriyl-tris (ω-trimethyl ether-, dodecanoate, poly(oxy-1,2-ethanediyl), α, α′, α″- 1,2,3-propanetriyl-tris (ω-hydroxy-, monooctadecanoate, ethoxylated C11-14 iso-alcohols, ethoxylated C12-16 alcohols, fatty acids, C10-16 alcohols, ethoxylated, ethoxylated 2,4,7,9-tetramethyl-5-decyn-4,7-diol, 2-[2-[2-[2-[2-[2-(2-dodecoxyethoxy) ethoxy]ethoxy]ethoxy]-ethoxy]ethoxy]ethanol, poly(oxy-1,2-ethanediyl), α-hydro- ω-hydroxy-, mono-C8-10-alkyl ethers, ethers with 1,2-dodecanediol (1:1) and castor oil.

In another aspect, alone or in combination with any one of the previous aspects, the antioxidant/stabilizer is at least one of tocopherol, tocopherol acetate, ascorbic acid, isoascorbic acid, sorbic acid, β-cyclodextrin, 2-hydroxypropyl-β-cyclodextrin, ethylenediaminatetetraacetic acid (EDTA), iminodisuccinic acid, propylene glycol alginate, calcium alginate, carob bean gum, gellan gum, carrageenan, polydextrose, hyaluronic acid, retinyl palmitate, saponin glycoside, clinoptilolite, calcium silicate, potassium bisulfite, sodium metabisulfite, sodium sulfite, sodium benzoate, sodium salicylate, sodium propionate, calcium propionate, poly (α-olefin sulfonate) sodium salt, poly (α-olefin sulfonate) potassium salt, croscarmellose sodium, sodium starch glycolate and crospovidone.

In another aspect, alone or in combination with any one of the previous aspects, the polar dispersant is at least one of propylene glycol, glycerol, sorbitol, glyceryl-7 ethoxylate, sodium tartrate, sodium gluconate, 2-amino-2-methyl-1-propanol, α,ω-dihydroxy-poly(oxyethylene)-poly(oxy-propylene) block copolymer, hydroxylated lecithin, sodium lauryl sarcosinate, polyoxyethylene (20) sorbitan monooleate, polyoxyethylene (20) sorbitan monolaurate, polyglyceryl 10-laurate, PEG-7 glyceryl cocoate, sodium tripolyphosphate, sodium pyrophosphate, and poly(N-vinyl pyrrolidone).

In another aspect, alone or in combination with any one of the previous aspects, the ionophoric electrolyte salt is at least one of sodium chloride, sodium sulfate, sodium acetate, sodium hydrogen phosphate, sodium citrate, sodium edetate, potassium citrate, potassium chloride, potassium carbonate, potassium nitrate, potassium bisulfate, and calcium dihydrogen phosphate.

In a second example, a method of reducing ammonium level of an animal litter is provided, the method comprising contacting animal litter before or after the animal litter comprises excreta with an amount of the animal treatment composition comprising the at least one sulfo-oxo compound of any of the previous examples and reducing ammonia level of the animal litter to less than or equal to 25 ppm is for at least 7 days. In another aspect, alone or in combination with any one of the previous aspects, the maintaining ammonia level of the animal litter to less than or equal to 25 ppm is for at least 14 days. In another aspect, alone or in combination with any one of the previous aspects, the maintaining ammonia level of the animal litter to less than or equal to 25 ppm is for at least 21 days.

In another aspect, alone or in combination with any one of the previous aspects, the animal treatment composition further comprises at least one carboxylic acid defined by formula:

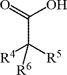

where R⁴, R⁵ and R⁶ are independently hydrogen, substituted or unsubstituted alkyl, substituted or unsubstituted alkenyl, substituted or unsubstituted aryl, substituted or unsubstituted cycloalkyl, vinyl, vinylalkyl, vinylaryl, halide, substituted or unsubstituted haloalkyl, hydroxy, substituted or unsubstituted hydroxyalkyl, substituted or unsubstituted alkoxyalkyl, carboxyl, alkylene carboxylate, vinyl carboxylate, allyl, allyl carboxylate, substituted or unsubstituted imino, phosphonobutyl, or pyruvyl, and wherein any two of R⁴, R⁵, and R⁶ can optionally be joined together with the carbon they are attached to form a substituted or unsubstituted cycloalkyl ring or a substituted or unsubstituted aryl ring, or a substituted or unsubstituted heteroaryl ring of 3-7 atoms.

In a third example, a method of providing a fertilizer additive or improved fertilizer from litter is provided, the method comprising: contacting litter before or after the animal litter comprises excreta with the animal litter treatment of any one of the previous aspects; retaining an effective amount of urea and ammonia nitrogen as ammonium salts compared to litter comprising excreta without contact with the animal litter treatment composition of any one of the previous aspects; and providing a fertilizer additive or an improved fertilizer.

In one aspect, the effective amount is about 30 weight percent compared to litter comprising excreta without contact with the animal litter treatment composition of any one of the previous aspects.

In a fourth example a manure amendment is provided, the manure amendment comprising animal litter after the animal litter comprises excreta in combination with an amount of the animal treatment composition of any one of the previous aspects capable of conserving an amount of urea content of the manure.

### BRIEF DESCRIPTION OF THE DRAWINGS

In order to understand and to see how the present disclosure may be carried out in practice, examples will now be described, by way of non-limiting examples only, with reference to the accompanying drawings, in which:

FIG. 1. depicts bacterial metabolism of one aralkyl sulfonic acid representing a series of enzyme catalyzed and chemical reactions, 1) and (i), (ii), (iii), that result in the release of 3 moles of hydronium per mole of sulfo-oxo compound.

FIGS. 2A, 2B, 2C, and 2D graphically depicts ammonia abatement and pH levels of poultry litter media treated with exemplary presently disclosed compositions verses controls.

### DETAILED DESCRIPTION

Provided herein is an animal litter treatment composition. In one aspect the animal litter treatment composition controls ammonia, above and within litter. In one aspect the animal litter treatment composition retains an effective amount of urate, urea, and nitrogen as ammonium salts within the litter, making the litter useful as fertilizer or a fertilizer additive.

As used herein, the term “alkyl” is art-recognized, and refers to both unsubstituted alkyl groups and substituted alkyl groups; however, substituted alkyl groups are also specifically referred to herein by identifying the specific substituent(s) on the alkyl group. In certain examples, the term “alkyl” refers to a C1-C10 alkyl group. For example, the term “alkyl” refers to a C1-C6 alkyl group, e.g., a straight chain C1-C6 alkyl group. For example, the term “alkyl” refers to a C3-C12 branched chain alkyl group. For example, the term “alkyl” refers to a C3-C8 branched chain alkyl group. Representative examples of alkyl include, but are not limited to, methyl, ethyl, n-propyl, iso-propyl, n-butyl, sec-butyl, iso- butyl, tert-butyl, n-pentyl, isopentyl, neopentyl, and n-hexyl. Substituted alkyl refers to at one or more substituents such as halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfenyl, sulfonyl, sulfinyl, sulfamyl, sulfenic, sulfinic, sulfonic, sulfamic, sulfonimido, sulfonamido, ketone, aldehyde, ester, heterocyclic, aromatic or heteroaromatic moieties, fluoroalkyl (such as trifluromethyl), cyano, or the like.

As used herein, the term “cycloalkyl” means monocyclic or bicyclic, or bridged, saturated carbocyclic rings, each having from 3 to 12 carbon atoms. Some cycloalkyls have 5-12 carbon atoms in their ring structure, and may have 6-10 carbons in the ring structure. Cycloalkyl groups are optionally substituted.

As used herein, the term “(cycloalkyl)alkyl” as used herein refers to an alkyl group substituted with one or more cycloalkyl groups. An example of cycloalkylalkyl is cyclohexylmethyl group.

As used herein, the term “alkylene” is art-recognized, and refers to a diradical obtained by removing two hydrogen atoms of an alkyl group, as defined above. In one embodiment an alkylene refers to a disubstituted alkane, i.e., an alkane substituted at two positions with substituents such as, independently, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfenyl, sulfonyl, sulfinyl, sulfamyl, sulfenic, sulfinic, sulfonic, sulfamic, sulfonimido, sulfonamido, ketone, aldehyde, ester, heterocyclyl, aromatic or heteroaromatic moieties, fluoroalkyl (such as trifluromethyl), cyano, or the like. For example, a “substituted alkyl” is inclusive of an “alkylene” and a branched or straight chain alkyl.

As used herein, the term “alkenyl” as used herein is a hydrocarbon group of from 2 to 8 carbon atoms with a structural formula containing at least one carbon-carbon double bond. Asymmetric structures such as (A1A2)C=C(A3A4) are intended to include both the E and Z isomers. This can be presumed in structural formula wherein an asymmetric alkene is present, or it can be explicitly indicated by the bond symbol C═C. The alkenyl group can be substituted with one or more groups including, but not limited to, optionally substituted, alkyl, cycloalkyl, cycloheteroalkyl,, alkoxy, alkenyl, cycloalkenyl, cycloheteroalkenyl, aryl, heteroaryl, aldehyde, amino, carboxylic acid, ester, ether, halide, hydroxy, ketone, azide, nitro, silyl, sulfo-oxo, or thiol.

As used herein, the term “aryl” is a term of art and as used herein refers to includes monocyclic, bicyclic and polycyclic aromatic hydrocarbon groups, for example, benzene, naphthalene, anthracene, and pyrene. Typically, an aryl group contains from 6-10 carbon ring atoms (i.e., (C₆-C₁₀)aryl). The aromatic ring may be substituted at one or more ring positions with one or more substituents, such as halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfenyl, sulfonyl, sulfinyl, sulfamyl, sulfenic, sulfinic, sulfonic, sulfamic, sulfonimido, sulfonamido, sulfonate, ketone, aldehyde, ester, heterocyclyl, aromatic or heteroaromatic moieties, fluoroalkyl (such as trifluromethyl), cyano, or the like. The term “aryl” also includes polycyclic ring systems having two or more cyclic rings in which two or more carbons are common to two adjoining rings (the rings are “fused rings”) wherein at least one of the rings is an aromatic hydrocarbon, e.g., the other cyclic rings may be cycloalkyls, cycloalkenyls, cycloalkynyls, aryls, heteroaryls, and/or heterocyclics. For example, the term “aryl” refers to a phenyl group, and substituted aryl includes phenylsulfonate. For example, aryl refers to an aralkylene, and substituted aralkylene includes aralkylene sulfonate, aralkylene carboxylate, and the like. The term “aryl” also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term “non-heteroaryl,” which is also included in the term “aryl,” defines a group that contains an aromatic group that does not contain a heteroatom. Exemplary heteroaryl groups include azaindolyl, benzo(b)thienyl, benzimidazolyl, benzofuranyl, benzoxazolyl, benzothiazolyl, benzothiadiazolyl, benzotriazolyl, benzoxadiazolyl, furanyl, imidazolyl, imidazopyridinyl, indolyl, indolinyl, indazolyl, isoindolinyl, isoxazolyl, isothiazolyl, isoquinolinyl, oxadiazolyl, oxazolyl, purinyl, pyranyl, pyrazinyl, pyrazolyl, pyridinyl, pyrimidinyl, pyrrolyl, pyrrolo[2,3-d]pyrimidinyl, pyrazolo[3,4-d]pyrimidinyl, quinolinyl, quinazolinyl, triazolyl, thiazolyl, thiophenyl, tetrahydroindolyl, tetrazolyl, thiadiazolyl, thienyl, thiomorpholinyl, triazolyl or tropanyl, and the like. The “heteroaryl” may be substituted at one or more ring positions with one or more substituents as defined herein.

As used herein, the terms “aralkyl” or “arylalkyl” are used interchangeably and refer to a linear or branched alkyl group of 1-6 carbons that is substituted with an aryl group. Additionally, the aralkyl group is optionally substituted.

As used herein, the term “aralkoxy” wherein the oxygen atom is the point of attachment, or “aroxy alkyl” wherein the point of attachment is on the aryl group refers to a group that includes monocyclic, bicyclic or tricyclic, carbon ring system, that includes fused rings, wherein at least one ring in the system is aromatic.

As used herein, the term “carboxylic acid” is represented by a formula —C(O)OH.

As used herein, the term “carboxylate” is represented by a formula —C(O)O⁺M⁻, where M- is ammonium or metal cation.

As used herein, the term “hydroxyl” is represented by a formula —OH.

As used herein, the terms “amine” or “amino” are terms of art and as used herein refer to both unsubstituted and substituted amines and salts thereof, e.g., -NHRa, —NRaRb, or —N⁺RaRbaRc wherein Rₐ, R_{b}, and R_{c} each independently represent a hydrogen, an alkyl, an alkenyl, —(CH₂)ₓ—R_{d}, or Rₐ and R_{b}, taken together with the N atom to which they are attached complete a heterocycle having from 4 to 8 atoms in the ring structure; R_{d} represents an aryl, a cycloalkyl, a cycloalkenyl, a heterocyclyl or a polycyclyl; and x is zero or an integer in the range of 1 to 8.

As used herein, the term “alkylamino” is represented by a formula -NH(alkyl).

As used herein, the term “dialkylamino” is represented by a formula -N(alkyl)₂.

As used herein, the term “sulfo-acid” is represented by a formula —S(O2)—OH.

As used herein, the term “carboxy”, is represented by a formula —CO₂H group.

As used herein, the term “sulfonyl” refers to a sulfo group represented by a formula —S(O)2O—Z, where Z is an alkyl, halogenated alkyl, alkenyl, alkynyl, aryl, heteroaryl, cycloalkyl, cycloalkenyl, heterocycloalkyl, heterocycloalkenyl group, or substituted or unsubstituted sulfonyl radical resulting, for example, in a symmetrical or asymmetrical sulfonic anhydride, or a substituted or unsubstituted carbonyl radical resulting, for example, in a symmetrical or asymmetrical sulfonic-carboxylic anhydride represented by a formula —(SO2)—O—C(O)—Z2 where Z2 is an alkyl, halogenated alkyl, alkenyl, alkynyl, aryl, heteroaryl, cycloalkyl, cycloalkenyl, heterocycloalkyl, or heterocycloalkenyl group. Z2 can optionally be substituted.

As used herein, the term “alkoxy” as used herein means an alkyl group, as defined herein, appended to the parent molecular moiety through an oxygen atom. Representative examples of alkoxy include, but are not limited to, methoxy, ethoxy, propoxy, 2-propoxy, butoxy, tert-butoxy, pentyloxy, and hexyloxy.

As used herein, the term “alkoxyalkyl” refers to an alkyl group substituted by an alkoxy group. For example, the term “alkoxyalkyl” specifically refers to an alkyl group that is substituted with one or more alkoxy groups.

As used herein, the term hydroxy” is a term of art represented by a formula-OH.

As used herein, the term “hydroxyalkyl”, means at least one hydroxy group, as defined herein, is appended to the parent molecular moiety through an alkyl group, as defined herein. Representative examples of hydroxyalkyl include, but are not limited to, hydroxymethyl, 2-hydroxyethyl, 3-hydroxypropyl, 2,3-dihydroxypentyl, and 2-ethyl-4-hydroxyheptyl.

As used herein, the term “halo” is a term of art is represented by a formula —F, —Cl, —Br, or —I, corresponding to fluorine, chlorine, bromine and iodine, respectively.

As used herein, the term “haloalkyl” as used herein refers to an alkyl group, as defined herein, wherein some or all of the hydrogens are replaced with halogen atoms.

As used herein, the term “substituted or unsubstituted,” if not defined above for a particular group, is inclusive of an unsubstituted group; a group substituted with at least one substituent selected from a deuterium atom, a halogen atom, a nitrile group, a nitro group, an amino group, an imino group, a vinyl group, a vinyl carboxylate group, an allyl group, an allyl carboxylate group, a pyruvyl group, a phosphonoalkyl group, a phosphine oxide group, an alkoxy group, an aryloxy group, a carbonyl group, a carboxylic acid group, a carboxylate group, an alkylsulfoxy group, an arylsulfoxy group, a sulfenyl group, a sulfonyl group, a sulfinyl group, a sulfamyl group, a sulfenic group, a sulfinic group, a sulfonic group, a sulfamic group, a sulfonimido group, a sulfonamido group, a sulfonate group, a branched or straight chain alkyl group, a cycloalkyl group, an alkenyl group, an aryl group, an aralkyl group, an aralkenyl group, an alkylaryl group, an alkylamine group, a heteroarylamine group, an arylamine group, and a heterocyclic group; or a group substituted with a substituent obtained by connecting two or more substituents described above. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

In one aspect, the animal litter treatment composition comprises at least one sulfo-oxo compound. In one aspect, the animal litter treatment composition comprises at least one sulfo-oxo compound in combination with one or more multifunctional carboxylic acids. In one aspect, the animal litter treatment composition comprises at least one sulfo-oxo compound in combination with one or more multifunctional carboxylic acids and further comprising at least one of urease inhibitors, urea biosynthesis activators, limiting substrates, enzyme cofactors, and cofactor mediators.

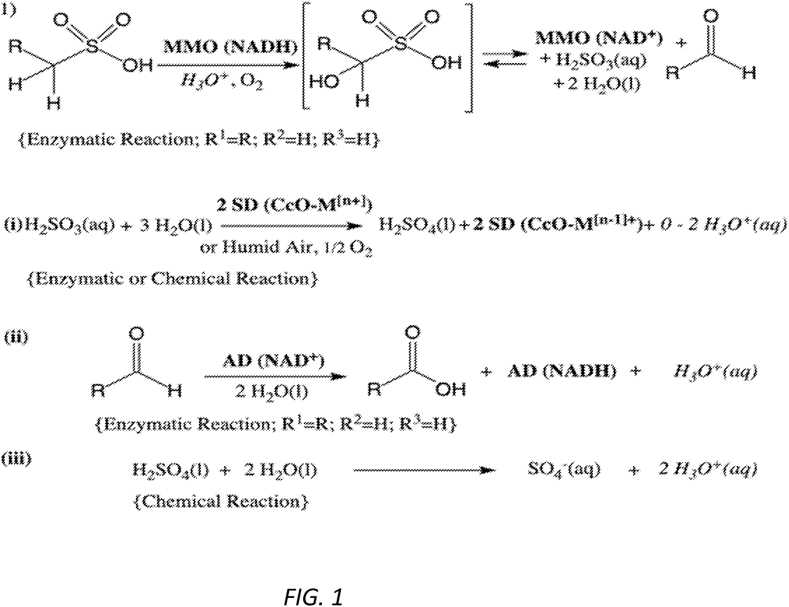

In one example, the at least one sulfo-oxo compound comprises an organic sulfonate and/or sulfate. Organic sulfonate and/or sulfate that slowly biodegrades while in contact with the litter via a known biological and/or chemical mechanism (see FIG. 1). A plurality of enzymes present in the litter manufactured by various microorganisms from both excreta from the animals and in the soil-like environment of the animal house. The concomitant release of hydronium ions thereby lowers the pH of the litter over the growth cycle of the animals. The estimated net release is 2 to 4 moles of hydronium ions per mole of sulfo-oxo compound present. The benefits to lowering the pH of the litter is two-fold: first, to mineralize ammonia that is present primarily due to the hydrolysis of urea in excreta that would otherwise equilibrate with water and volatilize to ammonia vapor, and second, to limit the activity of enzymes that exhibit a maximum rate at a pH of greater than about 7. The latter results in the minimization of the rate at which urea is produced by urate and the subsequent rate of hydrolysis of urea to ammonia.

The present disclosure provides compositions having longer-term efficacy litter treatments that reduce ammonia levels for more than 5 days and are readily applied in an animal house. It has been observed that the addition of at least one sulfo-oxo compound, alone or in combination with a carboxylic acid applied to litter slows the release of hydronium ions.

Examples of sulfo-oxo compounds include:

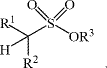

wherein R¹ and R² are independently hydrogen, a substituted or unsubstituted alkyl, a substituted or unsubstituted alkenyl, a substituted or unsubstituted aryl, amino, a substituted or unsubstituted alkylamino, halide, a substituted or unsubstituted haloalkyl, hydroxy, a substituted or unsubstituted hydroxyalkyl, or a substituted or unsubstituted alkoxyalkyl,
wherein, optionally, R¹ and R² together with the carbon the are attached form a substituted or unsubstituted cycloalkyl ring or a substituted or unsubstituted aryl ring, or a substituted or unsubstituted heteroaryl ring of 3-7 atoms,

R³ is hydrogen, a substituted or unsubstituted alkyl, a substituted or unsubstituted alkenyl, a substituted or unsubstituted aryl, a substituted or unsubstituted sulfonyl radical resulting in a symmetrical or asymmetrical sulfonic anhydride, or a substituted or unsubstituted carbonyl radical resulting in a symmetrical or asymmetrical sulfonic-carboxylic anhydride, or wherein, optionally, R² and R³ together with sulfur, the carbon and the oxygen they are attached, form a substituted or unsubstituted heteroalkyl or heteroalkenyl ring of 5-7 atoms.

Examples of sulfo-oxo compounds include, but are not limited to, structural isomers and homologs of alkane sulfonic acids such as methanesulfonic acid, ethanesulfonic acid, 1-propanesulfonic acid, 2-propanesulfonic acid, n-butanesulfonic acid, 2-butanesulfonic acid, 1-methyl-3-butanesulfonic acid, and their anhydrides. Examples of sulfo-oxo compounds also include, but are not limited to, structural isomers and homologs of hydrolyzable alkane sulfonic esters, such as phenyl methanesulfonate, methylphenyl methanesulfonate, p-(methylamino) phenyl methanesulfonate. Examples of sulfonic-carboxylic anhydrides include, but are not limited to, unsubstituted or substituted sulfonyl radicals such as methanesulfonyl radical, ethanesulfonyl radical, 1-propanesulfonyl radical, 2-propanesulfonyl radical, n-butanesulfonyl radical, 2-butanesulfonyl radical, 1-methyl-3-butanesulfonyl radical with unsubstituted or substituted carbonyl radicals such as methanecarbonyl radical, ethanecarbonyl radical, 1-propanecarbonyl radical, 2-propanecarbonyl radical, n-butanecarbonyl radical, 2-butanecarbonyl radical, 1-methyl-3-butanecarbonyl radical. Such mixed sulfonic-carboxylic anhydride compounds provide for the formation of both the sulfonic acid component and the carboxylic acid component upon hydrolysis.

In one example, the presently disclosed composition is provided as a concentrate composition suitable for transport to a location. In one example, the concentrate composition is configured to be diluted for use by an end-user. In one example, the presently disclosed concentrate composition is diluted (“diluted solution”) about 1 to about 100 times (v/v) with water or other aqueous solution. In one example, the concentrate composition is diluted from about 5 to 50 times (v/v) with water or other aqueous solution. In one example, the concentrate composition is diluted from about 10 to 30 times (v/v) with water or other aqueous solution. The diluted solution of the presently disclosed composition can be spread, sprayed, or otherwise directly or indirectly applied to both litter and manure.

In one example, the presently disclosed composition comprises at least one sulfo-oxo compound not limited to alkyl sulfonic acids in an amount from about 0.2% to about 40% by weight. In one example, the presently disclosed composition comprises at least one sulfo-oxo compound not limited to alkyl sulfonic acids in an amount from about 0.3% to about 10% by weight. In one example, the presently disclosed composition comprises at least one sulfo-oxo compound not limited to alkyl sulfonic acids in an amount from about 0.5% to about 5% by weight.

Examples of carboxylic acid include, but are not limited to the structure:

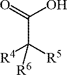

where R⁴, R⁵ and R⁶ are independently hydrogen, substituted or unsubstituted alkyl, substituted or unsubstituted alkenyl, substituted or unsubstituted aryl, substituted or unsubstituted cycloalkyl, vinyl, vinylalkyl, vinylaryl, halide, substituted or unsubstituted haloalkyl, hydroxy, substituted or unsubstituted hydroxyalkyl, substituted or unsubstituted alkoxyalkyl, carboxyl, alkylene carboxylate, vinyl carboxylate, allyl, allyl carboxylate, substituted or unsubstituted imino, phosphonobutyl, or pyruvyl, and wherein any two of R⁴, R⁵, and R⁶ can optionally be joined together with the carbon they are attached to form a substituted or unsubstituted cycloalkyl ring or a substituted or unsubstituted aryl ring, or a substituted or unsubstituted heteroaryl ring of 3-7 atoms.

Additional examples of carboxylic acids include, but are not limited to, citric acid, malic acid, malonic acid, tartaric acid, itaconic acid, mandelic acid, oxaloacetic acid, and 2-oxoglutaric acid. In one example, the presently disclosed composition comprises carboxylic acids not limited to alpha-hydroxy acids in an amount from about 0.2% to about 25% by weight. In one example, the presently disclosed composition comprises carboxylic acids not limited to alpha-hydroxy acids in an amount from about 0.3% to about 5% by weight. In one example, the presently disclosed composition comprises carboxylic acids not limited to alpha-hydroxy acids in an amount from about 0.5% to about 3% by weight.

In one example, citric acid is used as an alpha-hydroxy acid, e.g., a multifunctional carboxylic acid, used in combination with the at least one sulfo-oxo compound. Another example of a carboxylic acid is malic acid, used in combination with the at least one sulfo-oxo compound.

In one example, the disclosed composition is at least one or more carboxylic acids, such as, malic acid, and citric acid in combination with at least one or more amino acids, such as aspartic acid, and glutamic acid, in combination with at least one sulfo-oxo compound, such as methanesulfonic acid, so as to reduce or attenuate bacterial growth in the litter to which the disclosed composition is applied. In another example, at least one or more carboxylic acids are used in molar excess to the at least one sulfo-oxo compound so as to reduce or attenuate bacterial growth in the litter thereby maintaining a low pH for a longer period of time to which the disclosed composition is applied. In another example, the at least one sulfo-oxo compound are used in molar excess to at least one or more carboxylic acids so as to reduce or attenuate bacterial growth in the litter thereby maintaining a low pH for a longer period of time to which the disclosed composition is applied.

In accordance with one aspect of the present disclosure, there is provided a method of controlling animal litter ammonia, above and within litter, using a composition comprising at least one sulfo-oxo compound. In accordance with one aspect of the present disclosure, there is provided a method of controlling animal litter ammonia, above and within litter, using a composition comprising at least one sulfo-oxo compound in combination with one or more carboxylic acids. In accordance with one aspect of the present disclosure, there is provided a method of controlling animal litter ammonia, above and within litter, using a composition comprising at least one sulfo-oxo compound in combination with one or more carboxylic acids, and further comprising one or more of urease inhibitors, urea biosynthesis activators, limiting substrates, enzyme cofactors, and cofactor mediators.

Examples of urease inhibitors include, but are not limited to, N-(n-butyl)-thiophosphoric triamide, N-(n-butyl)-phosphoric triamide, N-(n-propyl)-thiophosphoric triamide, cyclohexylphosphoric triamide, phenyl phosphorodiamidate, monoamidothiophosphoric acid, acetohydroxamic acid, hydroxy thiourea, 2-mercaptoethanol, and 2-(N-3,4-dimethylpyrazole) succinic acid. In one example, the presently disclosed composition, as diluted, comprises urease inhibitors not limited to phosphoramidates in the amount from about 0.002% to about 2% by weight. In one example, the presently disclosed composition comprises urease inhibitors not limited to phosphoramidates in an amount from about 0.002% to about 2%. about 0.003% to about 0.5% by weight. In one example, the presently disclosed composition comprises urease inhibitors not limited to phosphoramidates in an amount from about 0.002% to about 2%. In one example, the presently disclosed composition comprises urease inhibitors not limited to phosphoramidates in an amount from about 0.004% to about 0.4% by weight.

Examples of urea biosynthesis activators include, but are not limited to, substituted amino acids such as N-acetyl-L-glutamate, N-acetyl-L-glutamic acid, N-acetyl-L-ornithine, N-acetyl-L-citrulline, N-carbamoyl-L-glutamate, N-carbamoyl-L-glutamic acid, N-carbamoyl phosphate, and (aminooxy) acetic acid. In one example, the presently disclosed composition comprises urea biosynthesis activators not limited to acetyl-substituted amino acids if used as the one or more carboxylic acids) in the amount from about 0.005% to about 5% by weight. In one example, the presently disclosed composition comprises urea biosynthesis activators not limited to acetyl-substituted amino acids in the amount from about 0.01% to about 0.5% by weight. In one example, the presently disclosed composition comprises urea biosynthesis activators not limited to acetyl-substituted amino acids in the amount from about 0.015% to about 0.1% by weight.

Examples of limiting substrates include, but are not limited to, amino acids such as L-aspartic acid, L-arginine-L-aspartate, L-ornithine-L-aspartate, L-citrulline-L-aspartate, L-arginine-L-glutamate, and L-glutamic acid. In one example, the presently disclosed composition comprises limiting substrates not limited to L-amino acids in the amount from about 0.01% to about 6% by weight. In one example, the presently disclosed composition comprises limiting substrates not limited to L-amino acids in the amount from about 0.02% to about 2% by weight. In one example, the presently disclosed composition comprises limiting substrates not limited to L-amino acids in the amount from about 0.03% to about 0.8% by weight.

Examples of enzyme cofactors include, but are not limited to, magnesium sulfate, manganese sulfate, magnesium potassium orthophosphate, and thiamine pyrophosphate. In one example, the presently disclosed composition comprises enzyme cofactors not limited to alkali earth salts in the amount from about 0.001% to about 1% by weight. In one example, the presently disclosed composition comprises enzyme cofactors not limited to alkali earth salts in the amount from about 0.005% to about 0.2% by weight. In one example, the presently disclosed composition comprises enzyme cofactors not limited to alkali earth salts in the amount from about 0.01% to about 0.1% by weight.

Examples of cofactor mediators include, but are not limited to, zinc citrate, zinc gluconate, zinc sulfate, salts of the at least one carboxylic acid, e.g., calcium citrate, calcium citrate malate, and calcium gluconate. In one example, the presently disclosed composition comprises cofactor mediators not limited to alkali earth salts in the amount from about 0.005% to about 1% by weight. In one example, the presently disclosed composition comprises cofactor mediators not limited to alkali earth salts in the amount from about 0.01% to about 0.5% by weight. In one example, the presently disclosed composition comprises cofactor mediators not limited to alkali earth salts in the amount from about 0.02% to about 0.2% by weight.

In accordance with one aspect of the present disclosure, there is provided a method of controlling animal litter ammonia, above and within litter, using a composition comprising at least one sulfo-oxo compound in combination with one or more carboxylic acids and further comprising antimicrobial agents, and amphiphilic phosphoric surfactants.

Examples of antimicrobial agents include, but are not limited to, oils derived from herbs, such as carvacrol, thymol and eugenol. In one example, the presently disclosed composition comprises antimicrobial agents not limited to substituted phenols in the amount from about 0.02% to about 4% by weight. In one example, the presently disclosed composition comprises antimicrobial agents not limited to substituted phenols in the amount from about 0.05% to about 1% by weight. In one example, the presently disclosed composition comprises antimicrobial agents not limited to substituted phenols in the amount from about 0.1% to about 0.5% by weight.

Examples of amphiphilic phosphoric surfactants include, but are not limited to, 2-((2,3-bis(oleoyloxy)propyl) dimethylammonio) ethyl ethyl phosphate, 1-Propanaminium, 3,3′,3″-[phosphinylidyne-tris(oxy)]-tris[N-(3-aminopropyl)-2-hydroxy-N,N-dimethyl-, N,N′,N″-tri-C6-C18 acyl trichloride, and Quaternary ammonium compound, coco alkyl(2,3-dihydroxypropyl) dimethyl, 3-phosphate esters, chlorides, sodium salts. In one example, the presently disclosed composition comprises amphiphilic phosphoric surfactants not limited to phospholipids in the amount from about 0.05% to about 5% by weight. In one example, the presently disclosed composition comprises amphiphilic phosphoric surfactants not limited to phospholipids in the amount from about 0.1% to about 2% by weight. In one example, the presently disclosed composition comprises amphiphilic phosphoric surfactants not limited to phospholipids in the amount from about 0.2% to about 1% by weight.

In accordance with one aspect of the present disclosure, there is provided a method of controlling animal litter ammonia, above and within litter, using a composition comprising at least one sulfo-oxo compound in combination with one or more carboxylic acids, further comprising one or more of terpene or terpenoid odorants and/or repellants, nonionic hydrocarbon emulsifiers, antioxidants/ stabilizers, polar dispersants and ionophoric electrolyte salts.

Examples of insect repellants include, but are not limited to, natural products or derivates thereof from citronellal, citronellol, geraniol, α-terpineol, o-phthalaldehyde, and pyrethrins. In one example, the presently disclosed composition comprises insect repellants not limited to natural products in the amount from about 0.001% to about 3% by weight. In one example, the presently disclosed composition comprises insect repellants not limited to natural products in the amount from about 0.01% to about 1% by weight. In one example, the presently disclosed composition comprises insect repellants not limited to natural products in the amount from about 0.02% to about 0.5% by weight.

Examples of nonionic hydrocarbon emulsifiers include, but are not limited to, Ethoxylated C11-14 iso-alcohols, Ethoxylated C12-16 alcohols, Fatty acids, C10-16 alcohols, ethoxylated, Ethoxylated 2,4,7,9-tetramethyl-5-decyn-4,7-diol) and Castor oil, hydrogenated, ethoxylated. In one example, the presently disclosed composition comprises nonionic hydrocarbon emulsifiers not limited to ethoxylated alcohols in the amount from about 0.04% to about 15% by weight. In one example, the presently disclosed composition comprises nonionic hydrocarbon emulsifiers not limited to ethoxylated alcohols in the amount from about 0.2% to about 5% by weight. In one example, the presently disclosed composition comprises nonionic hydrocarbon emulsifiers not limited to ethoxylated alcohols in the amount from about 0.5% to about 3% by weight.

Examples of antioxidant/stabilizers include, but are not limited to, tocopherol, tocopherol acetate, 2-hydroxypropyl-β-cyclodextrin, ethylenediaminetetraacetic acid, calcium propionate, propylene glycol alginate and poly (α-olefin sulfonate) sodium salt. In one example, the presently disclosed composition comprises antioxidants/stabilizers not limited to methylated phenols in the amount from about 0.0001% to about 1% by weight. In one example, the presently disclosed composition comprises antioxidants/stabilizers not limited to methylated phenols in the amount from about 0.001% to about 0.5% by weight. In one example, the presently disclosed composition comprises antioxidants/stabilizers not limited to methylated phenols in the amount from about 0.01% to about 0.2% by weight.

Examples of polar dispersants include, but are not limited to, propylene glycol, glycerol, glyceryl-7 ethoxylate, and hydroxylated lecithin. In one example, the presently disclosed composition comprises polar dispersants not limited to polyglycols in the amount from about 0.05% to about 10% by weight. In one example, the presently disclosed composition comprises polar dispersants not limited to polyglycols in the amount from about 0.1% to about 5% by weight. In one example, the presently disclosed composition comprises polar dispersants not limited to polyglycols in the amount from about 0.2% to about 2% by weight.

Examples of ionophoric electrolyte salts include, but are not limited to, sodium chloride, sodium sulfate, salts of the at least one carboxylic acid, (e.g., potassium citrate), potassium bisulfate, or calcium dihydrogen phosphate. The composition as diluted comprises ionophoric electrolyte salts not limited to alkali salts in the amount from about 0.1% to about 10%, preferably from about 0.2% to about 5% and most preferably from about 0.3% to about 3% by weight.

In accordance with another aspect of the present disclosure there is provided a method that conserves urea, within the litter, comprising treating the litter with the presently disclosed composition such that that animal litter or bedding so treated provides fertilizer.

In one example, the animal litter treatment composition presently described reduces ammonia levels above the litter below 25 ppm and maintains this level throughout an animal grow-out period for about 5 days to about 10 days after treatment. In one example, the animal litter treatment composition presently described reduces ammonia levels above the litter below 25 ppm and maintains this level throughout an animal grow-out period for about 7 days to about 14 days after treatment. In one example, the animal litter treatment composition presently described reduces ammonia levels above the litter below 25 ppm and maintains this level throughout an animal grow-out period for about 17 days to about 28 days after treatment.

Another object of the present disclosure is that the animal litter treatment composition reduces ammonia levels in an animal house without the need for high volume fans to exhaust ammonia-laden, conditioned air. The present disclosure provides for using only the minimal fan power required for circulation of fresh air into an animal facility to replace stale, humid air from evaporative cooling (latent) and respiration of animals, rather than dumping conditioned air into the environment with associated heat lost and energy wastage.

### EXAMPLES

The following examples are included only to demonstrate the disclosure, therefore all matter set forth is to be interpreted as illustrative and not in a limiting sense. All representative examples of the present disclosure and experimental methods were carried out according to CDC Biosafety Level 1.

### Poultry Manure Extract

A 50-pound bag of chicken manure was obtained fresh from a poultry house of a farm in Cleveland County, North Carolina. The warm manure was a pungent, dark brown, clumped, wet litter cake which comprised spent litter with wet poultry excreta mixed in and quills from feathers, some with attached webbing. The bulk moisture content of the litter cake was determined by heating and evaporation. About 20.00 grams was weighed into an aluminum dish and placed in a convection oven at 120± 2° C. for 90 minutes. The moisture content of the litter cake was found after weight loss to be: 43.2 ±0.3%. A 50:50 by weight slurry of manure in deionized water was prepared. The pH was immediately tested using a calibrated pH meter with a glass electrode. The pH of the slurry was found to be alkaline at 8.55 ±0.1.

A poultry manure extract to be used in subsequent examples was prepared using the following procedure: To a 16-oz. tall, sterile jar, 100 ml of sterile saline was added, sterile, adhesive-sealing, semipermeable film was affixed to the mouth of the jar and placed in an autoclave. For all examples, the autoclave heating cycle was 20 minutes at 121° C. and at a minimum 15 psig pressure. The sterile, semipermeable film remained intact and was used throughout all subsequent procedures for sealing. After cooling the saline solution to 25° C., 300 milligrams of microbiology select yeast extract powder was added. The yeast extract powder was dissolved in 85 grams of double-sterile saline by stirring and after 5 minutes, 42.80 grams of the wet manure (as poultry litter cake described above) was added. After rapid stirring and disintegration of the clumps a dark brown dispersion of the litter cake was formed after 10 minutes. The brown dispersion was placed in an incubator in air for 15 hours at 30 ±2° C. The coarse solids settled leaving a clear, light brown suspension. The top layer of the suspension was decanted yielding about 15 ml of poultry manure extract. The alkalinity of this extract was measured by titration again an aqueous standardized acid to pH 7.00 was 0.43 millimoles per gram of poultry manure extract. The extract was diluted with either alkaline nutrient broth or Stuart’s urea broth for use within 9 hours. All growth media for microbiology is prepared in advance and stored under refrigeration for up to 5 days before use using guidelines published by the following: Association of Water Technologies(AWT), American Society of Testing and Materials (ASTM), American Society for Microbiology (ASM), German Collection of Microorganisms and Cell Cultures [Deutsche Sammlung von Mikroorganismen und Zellkulturen] (DSMZ), American Type Culture Collection (ATCC), Clinical and Laboratory Standards Institute (CLSI), Environmental Protection Agency (EPA), Food and Drug Administration (FDA), United States Department of Agriculture (USDA), United States Pharmacopeia (USP), or the manufacturer. Any modifications to these procedures are detailed in this section otherwise these are as published by the professional organizations.

### Alkaline Nutrient Broth

An alkaline nutrient broth as part of poultry litter broth used in subsequent examples was prepared using the following procedure: To a 16-oz. tall, sterile jar, 100 ml of sterile water was added followed by 1.60 grams of microbiology grade, powdered alkaline peptone water, and shaken to dissolve the powder, then autoclaved in the sterile sealed jar. After cooling to 40° C., 2.00 grams of USP grade, powdered urea was added and stirred until a clear solution was obtained. After cooling to 20° C., the measured pH of the alkaline nutrient broth was 8.55 ±0.1.

### Poultry Litter Broth (PLB)

A poultry litter broth (PLB) was prepared by dissolution of 5 ml of the poultry manure extract into 95 ml of the alkaline nutrient broth in a 16-oz. tall, sterile sealed jar followed by incubation in air at 30 ±2° C. for 24 hours for immediate use as poultry litter media samples.

Most probable number, MPN analysis is a widely used statistical model to estimate the MPN of colony-forming units, CFU per gram in soil, water, and agricultural products. In a separate experiment that follows, a statistical analysis (after a correction for bias) was performed on the poultry manure extract using published procedures with one exception, the growth medium typically used for water analysis is lactose fermentation broth and applies to coliform bacteria that can ferment lactose as a food source. However, since bacteria that can hydrolyze urea as a food source is of primary focus in providing animal litter abatement as per the present disclosure, broth containing urea, e.g., Stuart’s urea broth was chosen as the growth media to carry out the MPN analysis of the poultry manure extract samples. Microorganisms that can grow with minimal nutrients by hydrolyzing urea are positive for urease. These generally include select organisms from the phylum: Firmicutes (gram-positive, soil bacteria) and the family: Enterobacteriaceae (gram-negative, enteric bacteria) but others can be present in poultry litter including some fungi.

A stock solution was prepared for inoculation using the following procedure: the poultry manure extract was diluted at 1 ml per 4 ml of sterile saline in a sterile test tube with screw cap. Three serial dilutions starting were carried out with this stock in triplicate by using a 1 ml inoculation of 9 ml each tube of Stuart’s Urea Broth including one uninoculated 10 ml tube of this broth as a blank. All 10 tubes with the caps loosened were incubated in air at 30 ±2° C. for 24 hours. As a presumptive test for urease, a color change from orange to pink is a positive test, therefore, the number of tubes for each dilution that turned bright pink in color was noted. The blank did not change from the original bright orange color of the Stuart’s Urea Broth, confirming a negative test for urease as expected.

Three of the sample tubes from the first two serial dilutions were positive, with none of the tubes from the final dilution changed in color, indicating a negative test for urease. Using the FDA online calculator MPNcalc.v1.2.0, a pattern of the positive tubes, 3-3-0 was entered with a dilution of the initial stock solution of 0.2 grams per ml and a 1 ml in 10 ml serial dilution scheme. The bias-corrected statistical count was computed as 74 CFU per gram for the stock dilution of the poultry litter broth. The poultry manure extract had an estimated bacterial count of 8.1 × 10³ CFU/ml. The urease-positive bacterial count of the poultry litter cake was estimated from the dilution data to be 2.4 × 10⁴ CFU/gram.

The inoculation of poultry litter media examples was carried out by preparing a composite culture of microorganisms necessary to demonstrate this present disclosure. A bacterial count of at least 5 × 10⁵ CFU/ml at the start of the test was targeted. Where possible CLSI M07-A8-ED9:2012 and M100-ED31:2021 standards were used to prepare the poultry litter broth by macrodilution of bacteria cultures for use in antimicrobial susceptibility testing of examples of this present disclosure. A standard inoculum or control culture was prepared by reactivation and propagation of a lyophilized pellet of DSM 33 - 03:2019, Sporosarcina pasteurii (Miquel 1889), type strain 22 (Soil). The DSMZ protocol (Leibniz Institute, Deutsche Sammlung von Mikroorganismen und Zellkulturen) for sterile opening of a tube-within-a-tube culture and the ATCC 11859 protocol for rehydration of a lyophilized culture were followed. ATCC medium 1376 was used to rehydrate the pellet. Using DSMZ medium #2 protocol, ATCC medium 1376 was supplemented with 20 grams per liter urea and tube macrodilution of the pellet was used to prepare a standard culture suspension. The viability of this standard culture was determined by enumeration of bacterial colonies by inoculation of CASO Agar plates using DSMZ 220a protocol. The culture plates were incubated at 30 ±2° C. in air. Propagation of colonies was complete in 48 hours. To simplify enumeration after 30 hours of incubation, a subculture was prepared by transferring 5 ml of the rehydrated culture suspension to 20 ml of DSM medium #2 so as to provide a specific dilution of a culture in a culture media with a known starting bacterial count in CFU per ml of solution. This stock subculture was enumerated by serial dilution in sterile tubes in 5 steps using 1 ml of inoculum in 9 ml of DSM medium #2. The macrodilution tubes were spread at 0.1 ml inoculant onto CASO Agar plates in duplicate and incubated at 30 ±2° C. in air for 20 hours. All the plates including a blank one, were enumerated by optical stereomicroscopy techniques using a USB camera interfaced to a PC running cell counting software. An average colony count was made over the whole plate for each dilution. The second dilution, 1 part in 10² by volume, was found to be the most accurate for colony counting. An average bacterial count of 5.5 × 10⁷ CFU per ml was determined for this dilution of the subculture stock. Dilutions and enumerations of this subculture stock were made frequently to conform to this bacterial count as the standard inoculum used for all subsequent examples disclosed herein. The original lyophilized pellet had an estimated bacterial count of 9 × 10⁹ CFU /gram of S. pasteurii (Miquel 1889) [Yoon et al. 2001, F.F. Lombard, T. Gibson 22]. All examples used this strain of bacteria at a standard inoculation rate of 1 ml subculture stock (SCS) and 4 ml of poultry litter broth in 100 ml of poultry litter media total for a resultant composite bacterial count of 5.5 ±0.5 × 10⁵ CFU /ml. All stock cultures and poultry litter broth were stored in the incubator in air at 30 ±2° C. until use.

### Ammonia Nitrogen and Related Measurements

Spectrocolorimetric methods were used to determine the total ammonia nitrogen solution concentrations of poultry litter media controls and those treated with the presently disclosed examples. The ammonia nitrogen concentration of the standards was plotted against their respective yellowness indices. A non-linear best-fit was made to the points of the calibration curve and the standard equation (see eq. 4) was used for dilutions of poultry litter media examples that follow. The correlation coefficient was 0.986 and the percent standard deviation from the curve fit to the data was 8.7%.

Colorimetric pipets, pull-tubes were used to measure ammonia vapor concentrations in parts per million above the poultry litter media solutions immediately following the requisite incubation period. The concentration range available from the selection of tubes was 0.25 ppm to 600 ppm for ammonia. An estimate of the value was made when the measured value exceeded the scale on the tube above 600 pm but only to indicate a high but consistent reading (e.g., 1000 ppm), with a reasonable expectation that the accuracy of measurements above the scale of the tube are in the nonlinear range. Draeger tubes have a reported percent standard deviation of 10 - 15% across the scale. In addition, pull-tubes to measure carbon dioxide were used sparingly in examples in the range 100 - 3000 ppm for comparison.

### Urea Measurements

Urea Quick Test Strips were used to estimate the urea concentration in the poultry litter media examples after inoculation and over time as a relative measure of the urea hydrolysis rate. The test strips used a colorimetric indicator to measure urea in dilute solutions of poultry litter media. The dilution of poultry litter media example was 1 part in 10² parts of saline. The strips indicate over the range of 0 - 1500 ppm urea. The relative urea concentration of examples after a correction for the dilution factor were reported in concentration units of molarity. All examples in this patent use this analytical methodology to estimate the relative concentration of urea over time.

### Uric Acid Measurements

Uric acid was measured using a commercially available indicator test kit that uses a uricase reagent with a chromogen that is sensitive to hydrogen peroxide. The optical density of the reagent indicator was reported by the manufacturer to be linear in uric acid concentration range 0 - 200 ppm. The uricase reagent turned deep pink in the presence of uric acid. The titration endpoint for the poultry litter media was determined relative to a standard, aqueous solution of uric acid. When a tube of 4 ml of reagent is titrated with 100 µl of the diluted stock solution and incubated at 30 ±2° C. for 30 minutes, the resultant endpoint is a deep pink color. This color change from orange to pink is taken as a presumptive positive test for uric acid. A color change from orange to yellow is taken as a presumptive negative test for uric acid. All examples use this analytical methodology to estimate the relative concentration of uric acid to the blank over time.

Exemplary animal litter treatment compositions of the present disclosure are summarized in Table 1 of Representative carboxylic acids (RCA) in combination with one or more sulfo-oxo compounds. Samples prepared without amendment for comparison are BASE and CONTROL. All the samples in Table 1 were incubated in air at 30 ±2° C. for 30 minutes. Poultry litter media examples were inoculated with the subculture stock by volume. The compositional examples of poultry litter media were then returned to the incubator in air at 30 ±2° C. for 24 hours. The pH of the solution was measured immediately following removal from the incubator.

TABLE 1

| (mL) | CAR | NBPT | MSA | AHA | ASP | NAG | Saline |
|---|---|---|---|---|---|---|---|
| BASE | 0 | 0 | 0 | 0 | 0 | 0 | 50 |
| CONTROL | 0 | 0 | 0 | 0 | 0 | 0 | 50 |
| PLM-4 (ø) | 5 | 1 | 5.7 | 0 | 2.8 | 2 | 33.5 |
| PLM-5 (MLA) | 5 | 1 | 8.5 | 12.1 | 2.8 | 1.2 | 19.4 |
| PLM-6 (MLA) | 5 | 1 | 11.3 | 12.1 | 2.8 | 1.2 | 16.6 |
| PLM-7 (ICA) | 5 | 1 | 8.5 | 12.1 | 2.8 | 1.2 | 19.4 |
| PLM-8 (CA) | 5 | 1 | 11.3 | 8.1 | 2.8 | 1.2 | 20.6 |
| PLM-9 (MDA) | 5 | 1 | 11.3 | 8.1 | 2.8 | 1.2 | 20.6 |
| PLM-10 (CA) | 5 | 1 | 11.3 | 8.1 | 2.8 | 1.2 | 20.6 |

Exemplary poultry litter media (PLM) solution examples of the present disclosure and comparative controls. Each table element represents the volume of each stock solution that was added to a bacterial growth medium or broth (See Table 2, Day 0) to produce a solution of poultry litter media (PLM). All solutions were diluted to the 100 ml mark with sterile saline including the Blank (not shown) except #10 which was diluted with stock #10. CAR= carvacrol; NBPT= N-(n-butyl) triphosphoric triamide; MSA= methanesulfonic acid; AHA= alpha-hydroxy acid; CA = citric acid; MLA = dl-malic acid; MDA = mandelic acid; ICA = itaconic acid; ASP = aspartic acid; NAG = N-acetyl-L-glutamic acid

### Stock Solutions

An alkaline urea broth (AUB) of 1.5 M was prepared and was used for examples.

A minimal yeast broth (MYB) of 0.2 mM was prepared and was used for examples. Stock solutions of representative examples of the present disclosure were prepared under sterile conditions and using common experimental techniques.

Stock Solution #1: Carvacrol (CAR) stock 0.17 M was prepared and was used for examples.

Stock Solution #2: A stock solution of N-(n-butyl) triphosphoric triamide (NBPT) of 0.025 M was prepared and was used for examples.

Stock Solution #3: A stock solution of methanesulfonic acid (MSA) of 0.44 N was prepared and was used for examples.

Stock solutions (#4, 5, 6, 7) of the following representative carboxylic acids: citric acid (CA), dl-malic acid (MLA), itaconic acid, (ICA) and mandelic acid (MDA) solutions of 0.62 N, 0.60 N, 0.61 N, and 0.62 N, respectively, were prepared and used for examples.

Stock Solution #8: A stock solution of aspartic acid (ASP) of 0.12 N was prepared with anhydrous magnesium sulfate of 0.025 M and zinc gluconate of 0.05 M and was used for examples.

Stock Solution #9: A stock solution of N-acetyl-L-glutamic acid (NAG) of 0.13 N was prepared and was used for examples.

Stock Solution #10: A stock solution of propylene glycol alginate (PGA) of 6 mM was prepared containing 0.06 M glycerol (GLY) and was used for examples.

A summary of biological cultures and growth media/ broth used to prepare poultry litter amendment examples and comparative controls (see Table 1) on Day 0 and subsequent additions to these solutions for maintenance over time as indicated in Table 2.

TABLE 2

| MEDIA [ml] | AUB | PLB | SCS | MYB | PLB | MYB | SCS | AUB | MYB | MYB |
|---|---|---|---|---|---|---|---|---|---|---|
| | DAY 0 | DAY 0 | DAY 0 | DAY 2 | DAY 10 | DAY 11 | DAY 11 | DAY 14 | DAY 16 | DAY 21 |
| BASE | 45 | 5 | 0 | 10 | 2 | 8 | 0 | 20 | 6 | 5 |
| CONTROL | 45 | 4 | 1 | 10 | 2 | 11 | 0.3 | 20 | 10 | 10 |
| PLM-4 | 45 | 4 | 1 | 10 | 2 | 10 | 0.3 | 20 | 2 | 10 |
| PLM-5 | 45 | 4 | 1 | 5 | 2 | 11 | 0.3 | 20 | 0 | 15 |
| PLM-6 | 45 | 4 | 1 | 5 | 2 | 11 | 0.3 | 20 | 4 | 20 |
| PLM-7 | 45 | 4 | 1 | 10 | 2 | 11 | 0.3 | 20 | 6 | 10 |
| PLM-8 | 45 | 4 | 1 | 10 | 2 | 15 | 0.3 | 20 | 7 | 15 |
| PLM-9 | 45 | 4 | 1 | 10 | 2 | 15 | 0.3 | 20 | 2 | 10 |
| PLM-10 | 45 | 4 | 1 | 5 | 2 | 15 | 0.3 | 20 | 3 | 10 |

Poultry litter media/broth used to prepare comparative controls and exemplary poultry litter amendment compositions of the present disclosure. The initial amount of broth plus biological culture was 50 ml for all solutions to which of 50 ml of either sterile saline or each volume of stock solution (Table 1) was added. The final solution volume was maintained at 100 ml by addition of minimal broth, including the Blank. AUB= alkaline urea broth; PLB = poultry litter broth; SCS = subculture stock; MYB = minimal yeast broth

In the control samples by day 8, the urea solution concentration fell to 80% of their initial values. The rate of growth of the bacteria in the poultry litter media falls as the limiting substrate, e.g., as urea is consumed. Concomitantly, as the average age of the bacterial population increases, a point is reached where urease biosynthesis slows and levels off. By day 7 the ammonia concentration in solution had fallen on average by 55% and the ammonia vapor concentration had fallen in the Base control by about 25%. As indicated in Table 2, the Base control differs from the Control in that it was not inoculated with soil bacteria, only bacteria from the poultry litter broth. Therefore, to maintain a thriving bacterial population, new bacterial growth must continue to replace the old bacteria and urea added in adequate supply in the poultry litter media examples to provide a representative litter environment of a poultry house. The ammonia concentration above the litter in a poultry house rises and falls (cycles) with the pH of the litter. Subsequently, urea hydrolysis by bacterial urease raises the pH of the litter and once the urea is consumed dissolved carbon dioxide lowers the pH. Therefore, to maintain the validity of the controls these two factors were investigated as a challenge study of litter amendment compositions.

Table 3 summarizes the change in pH over time of the PLM’s and controls. Table 3 summarizes the change in pH of PLM’s and controls over a three-week period.

TABLE 3

Change in pH of PLM’s with presently disclosed composition examples vs controls. All pH measurements were relative to saline [6.80] and standard buffer [7.00]

| | | | | | | | |
|---|---|---|---|---|---|---|---|
| pH | DAY 1 | DAY 2 | DAY 7 | DAY 11 | DAY 15 | DAY 18 | DAY 22 |
| BASE | 9.06 | 9.06 | 8.87 | 8.67 | 8.98 | 8.89 | 8.69 |
| CONTROL | 9.1 | 9.06 | 8.9 | 8.71 | 9.02 | 8.86 | 8.68 |
| PLM-4 | 2.3 | 2.96 | 8.02 | 8.55 | 8.19 | 8.11 | 8.03 |
| PLM-5 | 1.88 | 2.12 | 3.47 | 5.04 | 7.59 | 7.63 | 7.49 |
| PLM-6 | 1.63 | 1.73 | 2.34 | 3.51 | 4.46 | 6.9 | 7.42 |
| PLM-7 | 1.89 | 2.11 | 3.81 | 5.37 | 7.58 | 7.66 | 7.49 |
| PLM-8 | 1.63 | 1.75 | 2.51 | 4.05 | 7.04 | 7.67 | 7.52 |
| PLM-9 | 1.66 | 1.71 | 2.61 | 6.88 | 7.65 | 7.75 | 7.58 |
| PLM-10 | 1.67 | 1.78 | 2.46 | 4.57 | 6.94 | 7.62 | 7.45 |
| T=30±2° C. | | | | | | | |

For poultry litter media examples of Table 1, the total ammonia nitrogen of dilute solutions was measured immediately following removal from the incubator. The total ammonia nitrogen was determined by color spot measurements of volumetric dilutions of 1 part poultry litter media example to ca. 200 parts of sterile 0.22 µm filtered saline using common analytical techniques. The gas sampling and measurements were taken at 4 centimeters above the surface of the solutions of poultry litter media examples.

Following Table 1, on day 10, and day 11, additional bacteria were added to the controls and the exemplary poultry litter amendment compositions of the present disclosure to ensure sufficient bacterial urease was present. On day 14, 20 ml of alkaline urea broth (AUB) was added to the controls and the exemplary poultry litter amendment compositions of the present disclosure. On day 15, the controls exhibited recovery of the ammonia concentration in solution and in the vapor and the pH returned to the original value, whereas the exemplary poultry litter amendment compositions of the present disclosure showed a robustness by maintaining ammonia vapor concentrations at or below the threshold. All volumes for examples of the present disclosure were adjusted to 100 ml using minimal yeast broth (see Table 2, columns 5, 6, and 7). By day 11, the ammonia-nitrogen concentration in solution of the control were down significantly as shown in Table 4.

TABLE 4

Measured ammonia-nitrogen solution concentration in parts per million in PLMs of the present disclosure. All solution concentrations were corrected for saline and Blank

| | | | | | | | |
|---|---|---|---|---|---|---|---|
| [NH3-N(aq.)] (ppm) | DAY 1 | DAY 2 | DAY 7 | DAY 11 | DAY 15 | DAY 18 | DAY 22 |
| BASE | 3189 | 4558 | 2261 | 588 | 1880 | 2379 | 473 |
| CONTROL | 3962 | 4308 | 2515 | 914 | 4739 | 2639 | 657 |
| PLM-4 | 52 | 45 | 319 | 272 | 292 | 330 | 321 |
| PLM-5 | 37 | 75 | 177 | 271 | 395 | 397 | 768 |
| PLM-6 | 27 | 51 | 129 | 220 | 361 | 475 | 868 |
| PLM-7 | 49 | 68 | 163 | 228 | 391 | 332 | 779 |
| PLM-8 | 45 | 78 | 173 | 282 | 317 | 440 | 425 |
| PLM-9 | 37 | 36 | 152 | 257 | 284 | 244 | 228 |
| PLM-10 | 21 | 46 | 162 | 256 | 319 | 328 | 313 |
| T= 30±2° C. | | | | | | | |

Furthermore, the ammonia vapor concentration was also greatly reduced, for at least 7 days or longer, as summarized in Table 5, which provides the measured ammonia vapor in parts per million (ppm) of the PLMs over time vs. controls.

TABLE 5

Ammonia vapor concentration in parts per million above solutions of the PLM’s of the present disclosure over time vs. controls. At the end of day 2, minimal yeast broth was added to maintain a 100 ml volume according to Table 1 for all poultry litter media examples used

| | | | | | | | |
|---|---|---|---|---|---|---|---|
| [NH3(g)] (ppm) | DAY 1 | DAY 2 | DAY 7 | DAY 11 | DAY 15 | DAY 18 | DAY 22 |
| BASE | 1000 | 1000 | 750 | 200 | 800 | 1000 | 100 |
| CONTROL | 1000 | 1000 | 1000 | 200 | 1000 | 600 | 100 |
| PLM-4 | 0.6 | 2 | 45 | 200 | 50 | 40 | 23 |
| PLM-5 | 1.4 | 1 | 0.5 | 0.8 | 25 | 40 | 20 |
| PLM-6 | 1.2 | 2.2 | 0.8 | 1 | 0.8 | 7 | 18 |
| PLM-7 | 1 | 0.8 | 1.6 | 1.1 | 25 | 30 | 19 |
| PLM-8 | 1 | 1 | 1 | 0.6 | 7 | 30 | 17 |
| PLM-9 | 1.2 | 1.1 | 1 | 7 | 35 | 25 | 16 |
| PLM-10 | 1.2 | 1.5 | 0.5 | 0.6 | 10 | 60 | 20 |
| T= 30±2° C. | | | | | | | |

With reference to Table 5, the presently disclosed example PLM-4 (without at least one carboxylic acid) provides for an average ammonia vapor concentration of at least a factor of 10 below that of the threshold target of 20 ppm ammonia vapor concentration for at least 7 days. Also, with reference to Table 5, some of the presently disclosed examples, PLM-5 to PLM-10 have an average ammonia vapor concentration of at least a factor of 10 below that of the threshold target of 20 ppm ammonia vapor concentration for more than 7 days, more than 10 days, and more than 20 days.

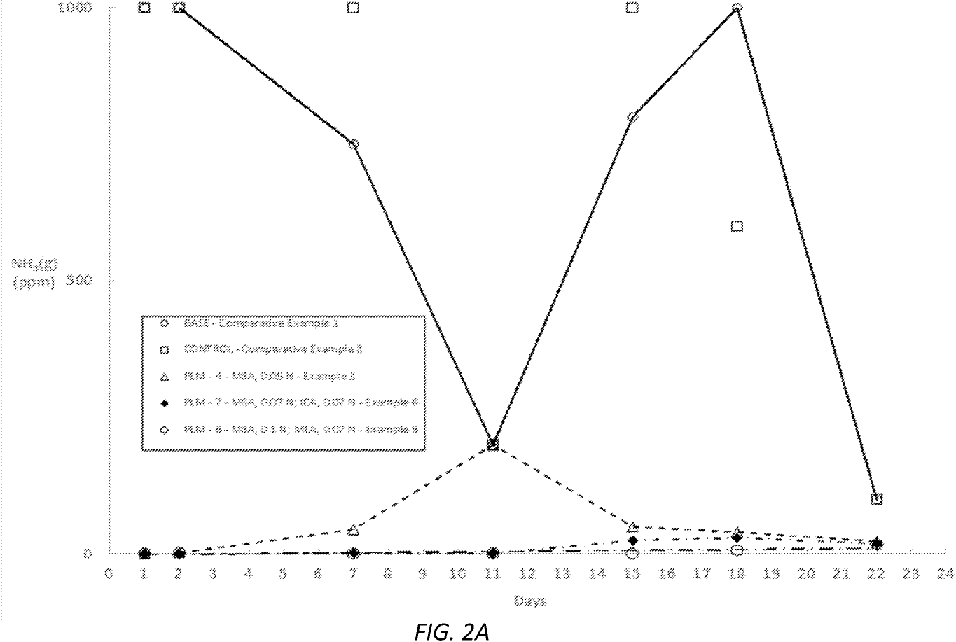

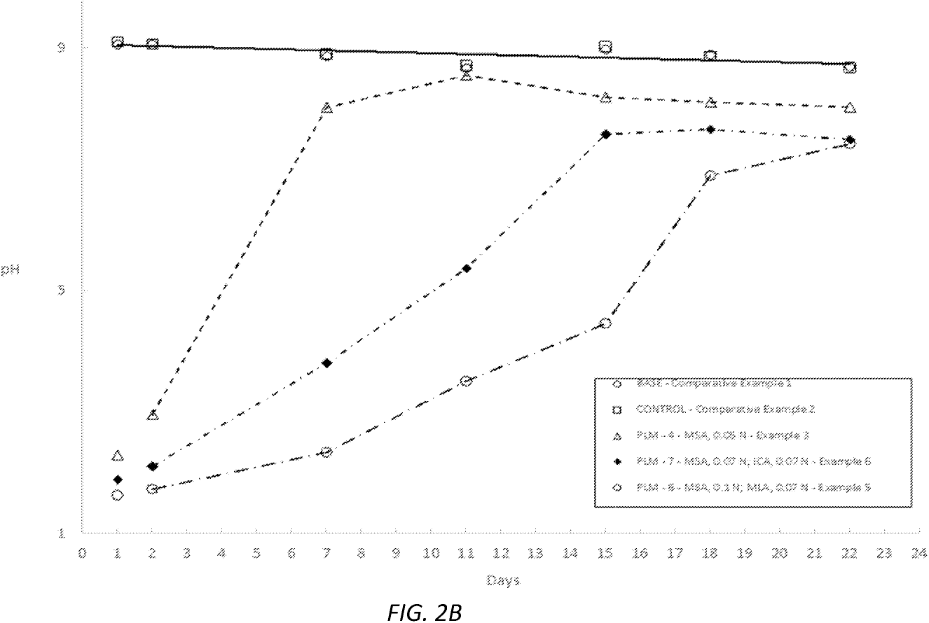

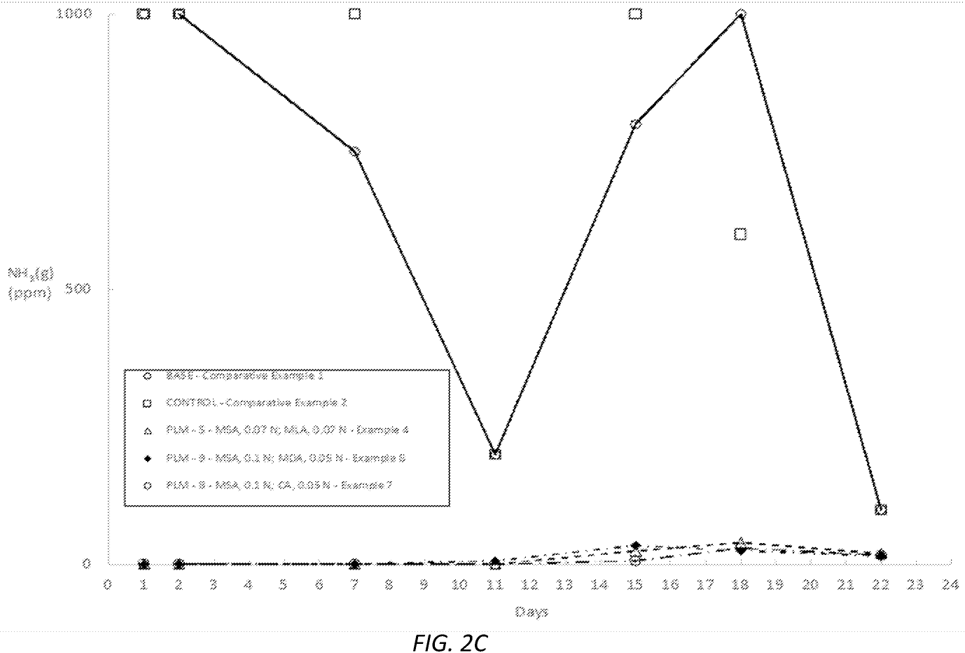

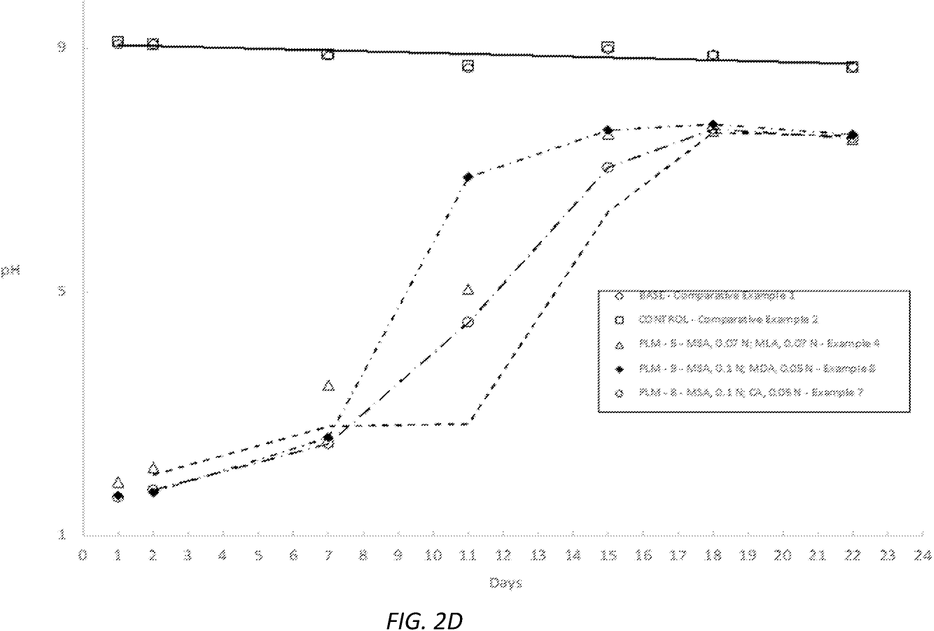

As indicated in Table 5 and FIG. 2A, by day 7, example PLM-4 without the carboxylic acid provided an ammonia vapor concentration below the threshold value of 20 ppm for a 7-day period before rising above the threshold value, which is believed occurred as a result of bacteria growth through urea hydrolysis, and amino acid metabolism, which raised the pH of the poultry litter medium.

As shown in Table 5 and FIG. 2A and, 2C, examples PLM-5 to PLM-10, which comprise the at least one sulfo-oxo compound and the one or more carboxylic acids, provided an ammonia vapor concentration of about 1 ppm on average with a pH below 4 (see, Table 3; and FIGS. 2B and 2D) as compared to the comparative examples. The carboxylic acid, in combination with the sulfo-oxo compound is, while a weaker acid, likely contributing to the total amount of dissociative hydronium ions available to neutralize ammonia, that, in principle, controls the rate of elimination of the hydroxy sulfo-oxo compound intermediate formed by metabolism of the microbes present in the litter, with the release of hydronium ions and further likely to act as an allosteric enzyme inhibitor.

TABLE 6

Measured urea solution molarity over incubation time in presently disclosed PLM examples vs. controls. All solution concentrations were relative to the Blank [0.75 M]

| | | | | |
|---|---|---|---|---|
| [UREA (aq.)] (M) | DAY 8 | DAY 14 | DAY 16 | DAY 21 |
| BASE | 0.12 | 0.04 | 0.45 | 0.12 |
| CONTROL | 0.12 | 0.04 | 0.25 | 0.12 |
| PLM-4 | 0.5 | 0.5 | 0.6 | 0.6 |
| PLM-5 | 0.45 | 0.25 | 0.25 | 0.45 |
| PLM-6 | 0.45 | 0.25 | 0.25 | 0.45 |
| PLM-7 | 0.25 | 0.25 | 0.45 | 0.45 |
| PLM-8 | 0.25 | 0.45 | 0.45 | 0.45 |
| PLM-9 | 0.25 | 0.25 | 0.25 | 0.25 |
| PLM-10 | 0.25 | 0.25 | 0.25 | 0.25 |
| T= 30±2° C. | | | | |

Table 6 summarizes the change in measured urea concentration of the presently disclosed PLM examples over time vs. controls. As indicated in Table 6, on day 8, the urea concentration of the control fell by 80% while the present examples fell to a lesser extent (33-66%). This was indicative of slower urea hydrolysis rate as compared to the controls for the present examples of the present disclosure.

In a broiler house, uric acid is the main excreta of the chickens during growth. Over time, limited only by oxygen and the moisture content of the litter, bacterial enzymolysis converts uric acid into urea, the main source of ammonia from metabolism of ureolytic bacteria present in animal litter. Uric acid (with urea) and smaller amounts of purine precursors to uric acid, xanthine, and hypoxanthine (not shown), are commonly reported as part of the crude protein content of poultry manure. As summarized in Table 7, uric acid reserves from the alkaline urea broth were depleted (see Table 7) in the exemplary compositions. Likewise, the urea concentration also decreased (see Table 6, Day 14) for these exemplary compositions verses controls.

Nonetheless, the presently disclosed compositions provide for retention of an effective amount of both urea, and ammonium salts that provide for the resultant treated litter to subsequently be useful as a fertilizer or fertilizer additive.

TABLE 7

Measured uric acid solution concentration in parts per million of exemplary PLMs of the present disclosure over time vs controls

| | | | |
|---|---|---|---|
| [Uric Acid (aq.)] | DAY 10 | DAY 17 | DAY 24 |
| BASE | 0 | 0 | 0 |
| CONTROL | 0 | 0 | 0 |
| PLM-4 | 10.8 | 1 | 0 |
| PLM-5 | 9.3 | 1.8 | 3 |
| PLM-6 | 8.1 | 1.5 | 3.7 |
| PLM-7 | 9.3 | 1.6 | 2.6 |
| PLM-8 | 7.2 | 2.6 | 3.7 |
| PLM-9 | 5.6 | 2.3 | 3 |
| PLM-10 | 10.8 | 2.6 | 3.7 |
| T= 30±2° C. | | | |

Measured urea and uric acid concentrations in solution from example PLM-6 appear to rise in contrast to the measurable increase in the aqueous ammonia-nitrogen concentration. While not limited to any theory, this result is possibly due to either lysis of the cytoplasmic membrane of the bacteria or enzymolysis of residual xanthine present in the litter extract, or both. The control, without uric acid reserves and with significantly less urea (80%) available for growth, the measured ammonia concentration in both the vapor and solution dropped precipitously in contrast to the examples of the present disclosure, where a lower level of urea hydrolysis was maintained after 21 days of growth.

On day 15 and 16, it was observed that the ammonia vapor and aqueous ammonia nitrogen concentrations (see Tables 5 and 4, respectively) begun to recover partially due to the higher urea concentration (see Table 6) for the control (and base) comparative examples. In contrast, the ammonia vapor concentrations of the examples of the present disclosure, PLM - 6, PLM-8, and PLM-10 as summarized in Table 5, are maintained and are well below the 20 ppm threshold even though the aqueous ammonia-nitrogen concentration has increased (see Table 4) and without a change in the urea concentration in solution (see Table 6). This surge in bacteria growth and concurrent metabolite production likely occurs in a similar fashion during the grow-out of animals and their litter, for example, poultry. By way of comparison, known litter amendments are not effective at controlling ammonia vapor concentration above the litter, nor are known litter amendments capable of retaining an effective amount of both urea, and ammonium salts that provides for the resultant treated litter to subsequently be useful as a fertilizer or fertilizer additive, thus demonstrating the improvement of the presently disclosed compositions and methods as an animal litter treatment.

The data shows another advantage of this presently disclosed compositions, where there is provided an animal litter treatment that controls ammonia, above and within litter. Administering the presently disclosed compositions to a litter provides an extended period during an animal grow-out for more than 10 days. For example, at day 18, example PLM-6, maintains an ammonia vapor concentration below the threshold value even as the aqueous ammonia-nitrogen concentration continues to increase at the expense of uric acid and subsequent urea hydrolysis. The mole fraction of aqueous ammonium ion (not shown) for the control increases (ca. 0.65 to 0.85) throughout the grow-out as the pH falls. In contrast, the mole fraction of ammonium ion remained practically constant (ca. 1.0) as the pH of the poultry litter media is held to below 7.4 using the presently disclosed composition, for example, PLM-6. By day 22, examples PLM-4 to PLM-10 fall in ammonia vapor concentration.

Broiler chicks are characteristically placed in the poultry house on or after day two at the start of the grow-out. The comparative examples, in Table 1, are the Base which contained only poultry litter broth and the Control that in addition was inoculated with a standardized strain of bacteria, both from Example 1. Clearly, without the animal litter treatment of the present disclosure, the health of chicks would be negatively impacted. As ammonia vapor concentrations rise above 20 ppm, chicks develop an increased susceptibility to respiratory diseases, such as, airsacculitis and infectious bronchitis. Longer term exposure can result in chickens with a compromised immune system that have increased susceptibility to infection under environmental stress. Both situations lead to loss of productivity. Thus, the presently disclosed animal litter treatments provide for improved health and environment of an animal, for example, poultry, during a growth cycle.

Notwithstanding, examples of poultry litter media retaining about a third of their excreta as urate and urea, and ammonia nitrogen as ammonium salts, specifically animal litter treated with the composition of this present disclosure, provide for an effective fertilizer and compost than those that were not treated with such an amendment.

Another aspect of this present disclosure is an animal litter treatment composition that controls ammonia, above and within litter, and that conserves the concentration of urea nitrogen in use such that the litter so treated provide a more effective fertilizer/compost source for crops. thus, the presently disclosed compositions can be provided as a concentrate or as a ready to apply solution that can be sprayed or otherwise dispensed on animal litter at the location of the animal facility. Used litter that has be contacted with the presently disclosed compositions, which comprises agrochemically effective amounts of urea and ammonia nitrogen as ammonium salts can be collected, dried, and used as fertilizer or as an additive to fertilizer. An agrochemically effective amount is any amount of urea and ammonia nitrogen as ammonium salts present in used animal litter greater than an amount of urea and ammonia nitrogen as ammonium salts present in used animal litter not treated with the present composition. The present compositions and methods can be used on various animal litter, comprising excreta or subsequently comprising excreta. Exemplary animal litter includes, for example, sawdust, straw, hay, corn husk, peanut shell, pecan shell, walnut shell, miscanthus grass, rice hull, wood chip, shredded paper, and combinations thereof. Litter comprising peanut shell, pecan shell, or walnut shell can be whole, ground or combinations thereof. The animal litter can be treated with the presently disclosed compositions before or after the animal litter comprises excreta to reduce ammonia above and/or within the animal litter comprising excreta, as well as providing used animal litter having agrochemically effective amounts of urea and ammonia nitrogen as ammonium salts for use as a fertilizer additive or as fertilizer.

While certain examples of the present disclosure have been illustrated with reference to specific combinations of elements, various other combinations may also be provided without departing from the teachings of the present disclosure. Thus, the present disclosure should not be construed as being limited to the particular exemplary examples described herein and illustrated in the Figures but may also encompass combinations of elements of the various illustrated examples and aspects thereof.

What is claimed is:

1. An animal litter treatment composition comprising:
at least one sulfo-oxo compound defined by formula: 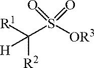
wherein R¹ and R² are independently hydrogen, a substituted or unsubstituted alkyl, a substituted or unsubstituted alkenyl, a substituted or unsubstituted aryl, amino, a substituted or unsubstituted alkylamino, halide, a substituted or unsubstituted haloalkyl, hydroxy, a substituted or unsubstituted hydroxyalkyl, or a substituted or unsubstituted alkoxyalkyl,
wherein, optionally, R¹ and R² together with the carbon the are attached form a substituted or unsubstituted cycloalkyl ring or a substituted or unsubstituted aryl ring, or a substituted or unsubstituted heteroaryl ring of 3-7 atoms,
R³ is hydrogen, a substituted or unsubstituted alkyl, a substituted or unsubstituted alkenyl, a substituted or unsubstituted aryl, a substituted or unsubstituted sulfonyl radical resulting in a symmetrical or asymmetrical sulfonic anhydride, or a substituted or unsubstituted carbonyl radical resulting in a symmetrical or asymmetrical sulfonic-carboxylic anhydride, or wherein, optionally, R² and R³ together with sulfur, the carbon and the oxygen they are attached, form a substituted or unsubstituted heteroalkyl or heteroalkenyl ring of 5-7 atoms; and
at least one carboxylic acid defined by formula: 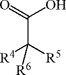
where R⁴, R⁵ and R⁶ are independently hydrogen, substituted or unsubstituted alkyl, substituted or unsubstituted alkenyl, substituted or unsubstituted aryl, substituted or unsubstituted cycloalkyl, vinyl, vinylalkyl, vinylaryl, halide, substituted or unsubstituted haloalkyl, hydroxy, substituted or unsubstituted hydroxyalkyl, substituted or unsubstituted alkoxyalkyl, carboxyl, alkylene carboxylate, vinyl carboxylate, allyl, allyl carboxylate, substituted or unsubstituted imino, phosphonobutyl, or pyruvyl, and wherein any two of R⁴, R⁵, and R⁶ can optionally be joined together with the carbon they are attached to form a substituted or unsubstituted cycloalkyl ring or a substituted or unsubstituted aryl ring, or a substituted or unsubstituted heteroaryl ring of 3-7 atoms.

2. The composition of claim 1, wherein the at least one sulfo-oxo compound is methanesulfonic acid, ethanesulfonic acid, 1-propanesulfonic acid, 2-propanesulfonic acid, 2-butanesulfonic acid, 3-butanesulfonic acid, 4-butanesulfonic acid, and anhydrides thereof.

3. The composition of claim 1, wherein the at least one sulfo-oxo compound is hydroxymethanesulfonic acid, methoxy-methanesulfonic acid, aminomethansulfonic acid, difluoromethanesulfonic acid, dichloro-methanesulfonic acid, methanesulfonic anhydride, phenyl methanesulfonic acid, 2,6-dimethylphenyl methanesulfonic acid, 2-methoxyphenyl methanesulfonic acid, 2-phenyl-1-ethanesulfonic acid, 3-hydroxy-2-phenyl-1-ethane sulfonic acid, 2-(p-sulfophenyl-1-ethanesulfonic acid, 2-(2,4-disulfophenyl)-1-ethanesulfonic acid, phenyl methanesulfonate, methylphenyl methanesulfonate, p-(methylamino) phenyl methanesulfonate, isenthionic acid, 2-aminoethane-1-sulfonic acid (taurine), N-methyltaurine, N, N-dimethyltaurine, 1,3-propanesultone, 3-hydroxypropanesulfonic acid, 3-aminopropane-1-sulfonic acid (homotaurine), (R)-2-amino-3-sulfopropanoic acid (cysteate), 4-hydroxy-1-butanesulfonic acid, and anhydrides thereof.

4. The composition of claim 1, wherein the at least one carboxylic acid is an alpha-hydroxy acid.

5. The composition of claim 1, wherein the at least one carboxylic acid is citric acid, isocitric acid, homocitric acid, prop-1-ene-1,2,3-tricarboxylic acid (aconitic acid), 2-phosphonobutane-1,2,4-tricarboxylic acid, malic acid, malonic acid, 2-hydroxy-2-phenylacetic acid (mandelic acid), tartaric acid, itaconic acid, oxaloacetic acid, adipic acid, glycolic acid, lactic acid, glutaric acid, 2-oxoglutaric acid, fumaric acid, succinic acid, gluconic acid, pyruvic acid, glyoxylic acid, salicylic acid, tropic acid, 3-hydroxy-3,7,11-trimethyldodecanoic acid (trethocanic acid), 2-hydroxybutanoic acid, 3-hydroxybutanoic acid, 4-hydroxybutanoic acid, and oxalic acid.

6. The composition of claim 1, further comprising a urease inhibitor.

7. The composition of claim 1, further comprising one or more of: a urea biosynthesis activator; a limiting substrate; an enzyme cofactor; a cofactor mediator; an antimicrobial agent; an amphiphilic phosphoric surfactant; and at least one of a terpene, a terpenoid, an odorant, a repellant, a nonionic hydrocarbon emulsifier, an antioxidant, a stabilizer, a polar dispersant, and an ionophoric electrolyte salt.

8. A method of reducing ammonia level of an animal litter, the method comprising:
contacting animal litter before or after the animal litter comprises excreta with an amount of an animal treatment composition comprising:
at least one sulfo-oxo compound defined by formula: 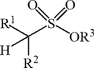
wherein R¹ and R² are independently hydrogen, a substituted or unsubstituted alkyl, a substituted or unsubstituted alkenyl, a substituted or unsubstituted aryl, amino, a substituted or unsubstituted alkylamino, halide, a substituted or unsubstituted haloalkyl, hydroxy, a substituted or unsubstituted hydroxyalkyl, or a substituted or unsubstituted alkoxyalkyl,
wherein, optionally, R¹ and R² together with the carbon the are attached form a substituted or unsubstituted cycloalkyl ring or a substituted or unsubstituted aryl ring, or a substituted or unsubstituted heteroaryl ring of 3-7 atoms,
R³ is hydrogen, a substituted or unsubstituted alkyl, a substituted or unsubstituted alkenyl, a substituted or unsubstituted aryl, a substituted or unsubstituted sulfonyl radical resulting in a symmetrical or asymmetrical sulfonic anhydride, or a substituted or unsubstituted carbonyl radical resulting in a symmetrical or asymmetrical sulfonic-carboxylic anhydride, or wherein, optionally, R² and R³ together with sulfur, the carbon and the oxygen they are attached, form a substituted or unsubstituted heteroalkyl or heteroalkenyl ring of 5-7 atoms; and
maintaining an ammonia level of the animal litter to less than or equal to 25 ppm is for at least 7 days.

9. The method of claim 8, wherein the maintaining ammonia level of the animal litter to less than or equal to 25 ppm is for at least 14 days.

10. The method of claim 8, wherein the maintaining ammonia level of the animal litter to less than or equal to 25 ppm is for at least 21 days.

11. The method of claim 8, wherein the at least one sulfo-oxo compound is hydroxymethanesulfonic acid, methoxy-methanesulfonic acid, aminomethansulfonic acid, difluoromethanesulfonic acid, dichloro-methanesulfonic acid, methanesulfonic anhydride, phenyl methanesulfonic acid, 2,6-dimethylphenyl methanesulfonic acid, 2-methoxyphenyl methanesulfonic acid, 2-phenyl-1-ethanesulfonic acid, 3-hydroxy-2-phenyl-1-ethane sulfonic acid, 2-(p-sulfophenyl-1-ethanesulfonic acid, 2-(2,4-disulfophenyl)-1-ethanesulfonic acid, phenyl methanesulfonate, methylphenyl methanesulfonate, p-(methylamino) phenyl methanesulfonate, isenthionic acid, 2-aminoethane-1-sulfonic acid (taurine), N-methyltaurine, N, N-dimethyltaurine, 1,3-propanesultone, 3-hydroxypropanesulfonic acid, 3-aminopropane-1-sulfonic acid (homotaurine), (R)-2-amino-3-sulfopropanoic acid (cysteate), 4-hydroxy-1-butanesulfonic acid, and anhydrides thereof.

12. The method of claim 8, wherein the animal treatment composition further comprises at least one carboxylic acid defined by formula: 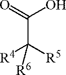
where R⁴, R⁵ and R⁶ are independently hydrogen, substituted or unsubstituted alkyl, substituted or unsubstituted alkenyl, substituted or unsubstituted aryl, substituted or unsubstituted cycloalkyl, vinyl, vinylalkyl, vinylaryl, halide, substituted or unsubstituted haloalkyl, hydroxy, substituted or unsubstituted hydroxyalkyl, substituted or unsubstituted alkoxyalkyl, carboxyl, alkylene carboxylate, vinyl carboxylate, allyl, allyl carboxylate, substituted or unsubstituted imino, phosphonobutyl, or pyruvyl, and wherein any two of R⁴, R⁵, and R⁶ can optionally be joined together with the carbon they are attached to form a substituted or unsubstituted cycloalkyl ring or a substituted or unsubstituted aryl ring, or a substituted or unsubstituted heteroaryl ring of 3-7 atoms.

13. The method of claim 8, wherein the at least one carboxylic acid is an alpha-hydroxy acid.

14. The method of claim 8, wherein the at least one carboxylic acid is citric acid, isocitric acid, homocitric acid, prop-1-ene-1,2,3-tricarboxylic acid (aconitic acid), 2-phosphonobutane-1,2,4-tricarboxylic acid, malic acid, malonic acid, 2-hydroxy-2-phenylacetic acid (mandelic acid), tartaric acid, itaconic acid, oxaloacetic acid, adipic acid, glycolic acid, lactic acid, glutaric acid, 2-oxoglutaric acid, fumaric acid, succinic acid, gluconic acid, pyruvic acid, glyoxylic acid, salicylic acid, tropic acid, 3-hydroxy-3,7,11-trimethyldodecanoic acid (trethocanic acid), 2-hydroxybutanoic acid, 3-hydroxybutanoic acid, 4-hydroxybutanoic acid, and oxalic acid.

15. The method of claim 8, wherein the animal treatment composition further comprises a urease inhibitor, wherein the urease inhibitor is at least one of N-(n-butyl)-thiophosphoric triamide, N-(n-butyl)-phosphoric triamide, N-(n-propyl)-thiophosphoric triamide, monoamidothiophosphoric acid, phenyl phosphorodiamidate, cyclohexylphosphoric triamide, N-(n-butyl)-N′-(methylolurea)-thiophosphoric triamide, N-(n-butyl)-N-(monomethylolurea)-thiophosphoric triamide, N-(n-butyl)-N′-(dimethylolurea)-thiophosphoric triamide, N-(n-butyl)-N′-poly(methylolurea)-thiophosphoric triamide, thiophos-phoryl triamide, phosphoryl triamide, dicyandiamide, 2-mercaptoethanol, cysteamine, boric acid, acetohydroxamic acid, humic acid, 1,4-benzoquinone, D-fructose, thiourea, dimethyl-thiourea, tetramethyl-thiourea, 2-{(E)-[(4-chlorophenyl)imino]-methyl}phenol copper(II), 2-{(E)-[(4-bromophenyl)-imino]methyl}phenol copper (II), [(Z)-2-methoxycarbonyl-3-(4-methylphenyl)prop-2-enyl]-phosphonic acid, 2-(N-3,4-dimethylpyrazole)succinic acid, and potassium dihydrogen phosphate.

16. A method of providing a fertilizer additive or an improved fertilizer from used animal litter, the method comprising:
contacting animal litter before or after the animal litter comprises excreta with the animal litter treatment composition comprising at least one sulfo-oxo compound defined by formula: I: 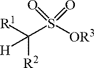
wherein R¹ and R² are independently hydrogen, a substituted or unsubstituted alkyl, a substituted or unsubstituted alkenyl, a substituted or unsubstituted aryl, amino, a substituted or unsubstituted alkylamino, halide, a substituted or unsubstituted haloalkyl, hydroxy, a substituted or unsubstituted hydroxyalkyl, or a substituted or unsubstituted alkoxyalkyl,
wherein, optionally, R¹ and R² together with the carbon the are attached form a substituted or unsubstituted cycloalkyl ring or a substituted or unsubstituted aryl ring, or a substituted or unsubstituted heteroaryl ring of 3-7 atoms,
R³ is hydrogen, a substituted or unsubstituted alkyl, a substituted or unsubstituted alkenyl, a substituted or unsubstituted aryl, a substituted or unsubstituted sulfonyl radical resulting in a symmetrical or asymmetrical sulfonic anhydride, or a substituted or unsubstituted carbonyl radical resulting in a symmetrical or asymmetrical sulfonic-carboxylic anhydride, or wherein, optionally, R² and R³ together with sulfur, the carbon and the oxygen they are attached, form a substituted or unsubstituted heteroalkyl or heteroalkenyl ring of 5-7 atoms; and
optionally, with at least one carboxylic acid defined by formula: 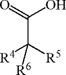
where R⁴, R⁵ and R⁶ are independently hydrogen, substituted or unsubstituted alkyl, substituted or unsubstituted alkenyl, substituted or unsubstituted aryl, substituted or unsubstituted cycloalkyl, vinyl, vinylalkyl, vinylaryl, halide, substituted or unsubstituted haloalkyl, hydroxy, substituted or unsubstituted hydroxyalkyl, substituted or unsubstituted alkoxyalkyl, carboxyl, alkylene carboxylate, vinyl carboxylate, allyl, allyl carboxylate, substituted or unsubstituted imino, phosphonobutyl, or pyruvyl, and wherein any two of R⁴, R⁵, and R⁶ can optionally be joined together with the carbon they are attached to form a substituted or unsubstituted cycloalkyl ring or a substituted or unsubstituted aryl ring, or a substituted or unsubstituted heteroaryl ring of 3-7 atoms;
retaining an effective amount of urea and ammonia nitrogen as ammonium salts compared to litter comprising excreta without contact with the animal litter treatment composition; and
providing a fertilizer additive or an improved fertilizer.

17. The method of claim 16, wherein the at least one carboxylic acid is an alpha-hydroxy acid.

18. The method of claim 16, wherein the effective amount is about 30 weight percent compared to the weight percent of litter comprising excreta without contact with the animal litter treatment composition.

19. A manure amendment comprising: animal litter before or after the animal litter comprises excreta in combination with an amount of an animal litter treatment composition comprising at least one sulfo-oxo compound defined by formula: 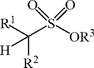
wherein R¹ and R² are independently hydrogen, a substituted or unsubstituted alkyl, a substituted or unsubstituted alkenyl, a substituted or unsubstituted aryl, amino, a substituted or unsubstituted alkylamino, halide, a substituted or unsubstituted haloalkyl, hydroxy, a substituted or unsubstituted hydroxyalkyl, or a substituted or unsubstituted alkoxyalkyl,
wherein, optionally, R¹ and R² together with the carbon the are attached form a substituted or unsubstituted cycloalkyl ring or a substituted or unsubstituted aryl ring, or a substituted or unsubstituted heteroaryl ring of 3-7 atoms,
R³ is hydrogen, a substituted or unsubstituted alkyl, a substituted or unsubstituted alkenyl, a substituted or unsubstituted aryl, a substituted or unsubstituted sulfonyl radical resulting in a symmetrical or asymmetrical sulfonic anhydride, or a substituted or unsubstituted carbonyl radical resulting in a symmetrical or asymmetrical sulfonic-carboxylic anhydride, or wherein, optionally, R² and R³ together with sulfur, the carbon and the oxygen they are attached, form a substituted or unsubstituted heteroalkyl or heteroalkenyl ring of 5-7 atoms; and
optionally, at least one carboxylic acid defined by formula: 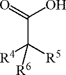
where R⁴, R⁵ and R⁶ are independently hydrogen, substituted or unsubstituted alkyl, substituted or unsubstituted alkenyl, substituted or unsubstituted aryl, substituted or unsubstituted cycloalkyl, vinyl, vinylalkyl, vinylaryl, halide, substituted or unsubstituted haloalkyl, hydroxy, substituted or unsubstituted hydroxyalkyl, substituted or unsubstituted alkoxyalkyl, carboxyl, alkylene carboxylate, vinyl carboxylate, allyl, allyl carboxylate, substituted or unsubstituted imino, phosphonobutyl, or pyruvyl, and wherein any two of R⁴, R⁵, and R⁶ can optionally be joined together with the carbon they are attached to form a substituted or unsubstituted cycloalkyl ring or a substituted or unsubstituted aryl ring, or a substituted or unsubstituted heteroaryl ring of 3-7 atoms;
wherein the manure amendment is capable of conserving an amount of urea and ammonia nitrogen as ammonium salts content of the animal litter comprising excreta.

20. The manure amendment of claim 19, wherein the at least one carboxylic acid is an alpha-hydroxy acid.
